(19) United States
(12) Patent Application Publication
(10) Pub. No.: US 2025/0072663 A1
(43) Pub. Date: Mar. 6, 2025

(54) Grease Containment Systems

(71) Applicant: The Grease Box LLC, Phoenix, AZ (US)

(72) Inventors: Amy Beaumont, Tempe, AZ (US); Markus Dale Hillman, Mesa, AZ (US); Carrie Beaumont, Tempe, AZ (US)

(73) Assignee: The Grease Box LLC, Phoenix, AZ (US)

(21) Appl. No.: 18/944,975

(22) Filed: Nov. 12, 2024

Related U.S. Application Data
(63) Continuation-in-part of application No. 18/377,169, filed on Oct. 5, 2023.
Application No. 18/377,169 is a continuation-in-part of application No. 16/984,646, filed on Aug. 4, 2020, now Pat. No. 11,812,895.

(51) Int. Cl. A47J 37/07

(52) U.S. Cl. CPC A47J 37/0786

(57) ABSTRACT

A fluid containment enclosure for collecting fluids from an outdoor cooking device including a universal bracket for mounting below the cooking device. The bracket includes leveling members for cooperating directly with the cooking device or selectively includes an adapter for mounting to the cooking device drain. The bracket includes rails on side surfaces. An enclosure for collecting fluid from the cooking device is selectively positioned to cooperate with the rails of the bracket.

### CROSS REFERENCE TO RELATED APPLICATIONS

This application is a continuation in part of U.S. application Ser. No. 18/377,169, which is a continuation in part of U.S. application Ser. No. 16/984,646 entitled “Grease Containment Systems” to Amy Beaumont et al., filed on Aug. 4, 2020; the disclosures of which are herein incorporated by reference.

### FIELD OF THE INVENTION

Generally, this invention relates to fluid and grease collection systems for use with an outdoor cooking device. More particularly this invention relates to providing a system for increased safety in grease containment in outdoor cooking devices, such as smokers, grills, etc.

### BACKGROUND OF THE INVENTION

Outdoor cooking devices collect juices and/or ash from the food as it is being cooked and then drain the juices and/or ash into a bucket through a drain. The bucket is open at the top and can easily be spilled if bumped by people, objects (like toys, balls, etc.) or a stream of water from a garden hose. Additionally, with an open top, water from rain, sprinklers, and garden hoses can mix with the grease and overflow or tip the bucket spilling the fluids, which are mostly grease. When the grease is spilled, it creates a mess. The grease may coat a surface in such a way as to create a slipping hazard and is difficult to clean up. Further, the grease attracts insects and other animals and over time can lead to undesirable smells in the area around the outdoor cooking device.

Likewise, the bucket and its contents, which are often hot, can be directly touched by people around the cooking device. Burns, particularly for children and pets, can be severe and are highly undesirable. Additionally, when the outdoor cooking device is used at higher temperatures, there is a risk of hot air exiting the drain and catching the grease on fire in the bucket.

### SUMMARY OF THE INVENTION

The present invention provides among other things, a system, relating to catching fluid drainage from an outdoor cooking device in an outdoor environment, comprising: at least one receptacle structured and arranged to receive and collect fluid draining from the outdoor cooking device generated by food cooking within a cooking enclosure of the outdoor cooking device; an enclosure structured and arranged to enclose such at least one receptacle; wherein such enclosure comprises at least one receptacle support structured and arranged to support such at least one receptacle, at least one mount structured and arranged to mount such enclosure on the outdoor cooking device, walls surrounding such at least one receptacle, a top and a bottom; wherein such enclosure comprises at least one insulation layer between such receptacle and such walls; wherein such enclosure is directly exposed to the outdoor environment while mounted on the outdoor cooking device.

Moreover, it provides such a system further comprising the outdoor cooking device. Additionally, it provides such a system wherein such outdoor cooking device comprises a wood pellet grill. Also, it provides such a system wherein such outdoor cooking device comprises a fluid drainage outlet in a side of such outdoor cooking device. In addition, it provides such a system wherein such outdoor cooking device comprises a fluid drainage outlet in a bottom of such outdoor cooking device. And it provides such a system wherein such enclosure further comprises an upper portion and a lower portion; wherein such upper portion comprises such top, such lower portion comprises such bottom and both such upper portion and such lower portion comprise such walls.

According to an aspect of the present inventions, a fluid containment system is provided which is mounted to the bottom, which is underneath, the cooking device. According to this aspect, a universal bracket is provided which cooperates with cooking device clip and is self-levelling or which includes a spout adapter for mounting to the cooking device drain or spout.

According to another aspect of the present invention, a spout mount, such as for mounting to the side of a cooking device, is configured to receive the cooking device spout and which extends upwardly from a top surface of the upper enclosure, thus rendering the mount according to this aspect and exterior mount inasmuch as it is exposed and not enclosed by the upper portion.

Further, the present invention provides such a system wherein at least one wall of such walls comprises at least one thermal vent structured and arranged to vent heat from the fluid collected in such at least one receptacle out of such enclosure. Even further, it provides such a system wherein such lower portion separates from such upper portion. Additionally, it provides such a system wherein such lower portion and such upper portion comprise interlocking rails structured and arranged to enable such lower portion to slide with respect to such upper portion. Even further, it provides such a system wherein such lower portion comprises at least one latching mechanism structured and arranged to latch together such upper portion and such lower portion and stopping relative motion between such upper portion and such lower portion.

Even further, it provides such a system wherein such upper portion comprises at least one fluid channel structured and arranged to redirect the fluid drainage from a fluid drainage outlet of the outdoor cooking equipment to such at least one receptacle. Moreover, it provides such a system wherein such upper portion comprises such at least one mount. Even further, it provides such a system wherein such lower portion comprises such at least one insulation layer. Even further, it provides such a system wherein such lower portion comprises such at least one receptacle support. Even further, it provides such a system wherein such lower portion comprises at least one handle.

Even further, it provides such a system wherein such lower portion comprises a watertight portion structured and arranged to collect fluid spills from such at least one receptacle. Additionally, it provides such a system wherein at least one wall of such walls comprises at least one thermal vent structured and arranged to vent heat from the fluid collected in such at least one receptacle out of such enclosure. Moreover, it provides such a system wherein such at least one thermal vent comprises at least one damper structured and arranged to dampen air flow through said enclosure. Even further, it provides such a system wherein such enclosure comprises a watertight portion structured and arranged to collect fluid spills from such at least one receptacle.

Additionally, it provides such a system wherein such at least one insulation layer comprises at least one air gap between such at least one receptacle and such walls. Even further, it provides such a system further comprising at least one fluid channel structured and arranged to redirect the fluid drainage from a fluid drainage outlet of the outdoor cooking equipment to such at least one receptacle. Moreover, it provides such a system wherein such at least one receptacle support comprises at least one wall protrusion structured and arranged to protrude from at least one wall of such walls and engage such at least one receptacle. Even further, it provides such a system wherein such top is solid.

In one aspect, this invention provides a system, relating to catching fluid drainage from an outdoor cooking device in an outdoor environment, comprising: the outdoor cooking device; at least one receptacle structured and arranged to receive and collect fluid draining from such outdoor cooking device generated by food cooking within a cooking enclosure of such outdoor cooking device; an enclosure structured and arranged to enclose such at least one receptacle; wherein such enclosure comprises at least one receptacle support structured and arranged to support such at least one receptacle, at least one mount structured and arranged to mount such enclosure on such outdoor cooking device, walls surrounding such at least one receptacle, a top and a bottom; wherein such enclosure comprises at least one insulation layer between such receptacle and such walls; wherein at least one wall of such walls comprises at least one thermal vent structured and arranged to vent heat from the fluid collected in such at least one receptacle out of such enclosure; wherein such at least one thermal vent comprises at least one damper structured and arranged to dampen air flow through said enclosure; and wherein such enclosure is directly exposed to the outdoor environment while mounted on such outdoor cooking device.

Additionally, it provides such a system wherein such outdoor cooking device comprises a wood pellet grill. Even further, it provides such a system wherein such enclosure further comprises an upper portion and a lower portion; wherein such upper portion comprises such top, such lower portion comprises such bottom and both such upper portion and such lower portion comprise such walls. Even further, it provides such a system wherein at least one wall of such walls comprises at least one thermal vent structured and arranged to vent heat from the fluid collected in such at least one receptacle out of such enclosure. Even further, it provides such a system wherein such lower portion separates from such upper portion.

Even further, it provides such a system wherein such lower portion and such upper portion comprise interlocking rails structured and arranged to enable such lower portion to slide with respect to such upper portion. Even further, it provides such a system wherein such lower portion comprises at least one latching mechanism structured and arranged to latch together such upper portion and such lower portion and stopping relative motion between such upper portion and such lower portion. Moreover, it provides such a system wherein such upper portion comprises at least one fluid channel structured and arranged to redirect the fluid drainage from a fluid drainage outlet of the outdoor cooking equipment to such at least one receptacle.

In some implementations a system relating to catching fluid drainage from an outdoor cooking device in an outdoor environment may comprise at least one receptacle structured and arranged to receive and collect fluid draining from the outdoor cooking device generated by food cooking within a cooking enclosure of the outdoor cooking device. The system may further comprise an enclosure structured and arranged to enclose the at least one receptacle, wherein the enclosure may comprise an upper portion comprising a top and side walls and a lower portion comprising a bottom and side walls surrounding the at least one receptacle, the lower portion being separable from the upper portion. The system may further comprise at least one mount configured to mount the enclosure to the outdoor cooking device.

Particular aspects may include one or more of the following features. The system may further comprise the outdoor cooking device. The outdoor cooking device may comprise a wood pellet grill. The mount may be welded to the outdoor cooking device. The upper portion of the enclosure may be permanently affixed to the outdoor cooking device. The lower portion and the upper portion may comprise interlocking rails structured and arranged to enable said lower portion to slide with respect to said upper portion. The system may further comprise at least one hinge coupled to at least one of the upper portion and the lower portion of the enclosure and the outdoor cooking device.

The mount may comprise at least one fluid channel structured and arranged to redirect the fluid drainage from a fluid and/or ash drainage outlet of the outdoor cooking equipment to the at least one receptacle. The lower portion of the enclosure may comprise at least one handle. The lower portion may comprise a watertight portion structured and arranged to collect fluid spills from said at least one receptacle. The at least one mount may comprise at least one notched mounting bracket.

In some implementations, a system, relating to catching fluid drainage from an outdoor cooking device in an outdoor environment may comprise the outdoor cooking device, a receptacle structured and arranged to receive and collect fluid draining from the outdoor cooking device generated by food cooking within a cooking enclosure of the outdoor cooking device, and an enclosure configured to enclose the at least one receptacle, the enclosure comprising at least one mount internal to the enclosure, the mount further comprising a fluid channel configured to redirect fluid drainage from a fluid drainage outlet of the outdoor cooking device to the receptacle.

Particular aspects may include one or more of the following features. The enclosure may be permanently affixed to the outdoor cooking device. The system may further comprise at least one hinge coupled to the enclosure and the outdoor cooking device. The enclosure may comprise at least one handle on an exterior surface of the enclosure. The enclosure may comprise an upper portion and a lower portion that are removably coupled.

Implementations of a system, relating to catching fluid drainage from an outdoor cooking device in an outdoor environment may comprise a receptacle structured and arranged to receive and collect fluid draining from the outdoor cooking device generated by food cooking within a cooking enclosure of the outdoor cooking device and an enclosure structured and arranged to enclose said at least one receptacle, the enclosure comprising at least two external protrusions configured to affix the enclosure to the outdoor cooking device such that a fluid drainage outlet of the outdoor cooking device extends not the enclosure and directs fluid from the outdoor cooking device into the receptacle.

Particular aspects may include one or more of the following features. The system may further comprise the outdoor cooking device. The outdoor cooking device may be a wood pellet grill. The enclosure may further comprise at least one thermal vent.

### BRIEF DESCRIPTION OF THE FIGURES

FIG. 1 shows a perspective view illustrating a fluid containment system according to the present invention;

FIG. 2 shows a perspective view, illustrating an enclosure of the fluid containment system, according to FIG. 1;

FIG. 3 shows an exploded view of the enclosure of the fluid containment system according to FIG. 2;

FIG. 4A shows a perspective view, illustrating an upper portion of the enclosure, according to FIG. 2;

FIG. 4B shows a perspective view, illustrating a lower portion of the enclosure, according to FIG. 2;

FIG. 5 shows the sectional view 5-5 of FIG. 2 according to FIG. 1;

FIG. 6 shows a perspective view illustrating a fluid containment system according to another aspect of the present invention;

FIG. 7 shows a perspective cutaway view, illustrating an interior of the enclosure of the fluid containment system, according to FIG. 6;

FIG. 8 shows a perspective view of a first alternative embodiment of a fluid containment system in use on an outdoor cooking device;

FIGS. 9A-9B show perspective views of the fluid containment system of FIG. 8 detached from the outdoor cooking device;

FIG. 10 shows an exploded view of the fluid containment system of FIGS. 8-9B;

FIG. 11 shows the fluid containment system of FIGS. 8-10 in and open position;

FIG. 12A shows the fluid containment system of FIGS. 8-11;

FIG. 12B shows the sectional view C-C of FIG. 12A;

FIG. 13A shows the fluid containment system of FIGS. 8-12B;

FIG. 13B shows the sectional view of D-D of FIG. 13A;

FIGS. 14-15 shows perspective views of an additional aspect of a fluid containment system configured to be welded to an outdoor cooking device;

FIG. 16 shows an exploded view of the fluid containment system of FIGS. 14-15;

FIG. 17 shows a perspective view of the fluid containment system of FIGS. 14-16 in an open position;

FIG. 18A shows the fluid containment system of FIGS. 14-17;

FIG. 18B shows the sectional view E-E of FIG. 18A;

FIG. 19A shows the fluid containment system of FIGS. 14-18B;

FIG. 19B shows the sectional view of F-F of FIG. 19A;

FIGS. 20-21 show perspective views of a fluid containment system configured to hingedly couple to an outdoor cooking device according to another aspect of the present invention;

FIG. 22 shows an exploded view the fluid containment system of FIGS. 20-21;

FIG. 23 shows a perspective view of a fluid containment system in an open position while hingedly coupled to an outdoor cooking device;

FIG. 24A shows a perspective view of the fluid containment system of FIGS. 20-23;

FIG. 24B shows the sectional view B-B of FIG. 24A;

FIGS. 25-26 and 28 show perspective views according to another aspect of a fluid containment system comprising at least one notched mounting bracket;

FIG. 27 shows an exploded view of the fluid containment system shown in FIGS. 25-26 and 28;

FIG. 29A shows a perspective view of the fluid containment system of FIGS. 25-28;

FIG. 29B shows the sectional view A-A of FIG. 29A;

FIG. 30 is a perspective view of a fluid containment system mounted on the bottom surface of the cooking device utilizing a bracket according to another aspect of the present invention;

FIG. 31 is a perspective view of a fluid containment system mounted to the side surface of the cooking device according to another aspect of the present invention wherein the mount extends outwardly from the upper portion;

FIG. 32 is a perspective (and partially exploded) view of the upper enclosure or universal bracket of the invention shown in FIG. 30;

FIG. 33 is a perspective view of the lower enclosure according to various aspects of the present invention being applied to the bracket and shown in a partially opened position;

FIG. 34 is an exploded view of the receptacle and the enclosure according to a selective aspect of the invention;

FIG. 35 is a perspective view of the universal bracket of the invention shown in FIG. 30 having a spout adapter according to one aspect of the invention;

FIG. 36 is an exploded view of the universal bracket of the invention shown in FIG. 30 having a spout adapter according to another aspect of the invention;

FIG. 37 is a perspective view of the universal bracket of the invention shown in FIG. 30 having a spout adapter according to FIG. 36;

FIG. 38 illustrates the mounting bracket coupled to the cooking enclosure;

FIG. 39 illustrates a deflector selectively used with the mounting bracket of FIG. 38.

FIG. 40 is a perspective view of a side mounted upper enclosure and mount wherein the mount extends outwardly from the upper enclosure;

FIG. 41 is a perspective view of the lower enclosure according to FIG. 40 being applied to the bracket in a partially opened position; and

FIG. 42 is a perspective view of a containment system of FIG. 40 in the operative position.

### DETAILED DESCRIPTION OF THE INVENTION

The present invention is understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” and “selective” or “selectively” mean that the subsequently described event or circumstance may or may not occur, and that the description includes instances where said event or circumstance occurs and instances where it does not. For the purposes of describing and defining the present invention it is noted that the use of relative terms, such as “substantially”, “generally”, “approximately”, and the like, are utilized herein to represent an inherent degree of uncertainty that is attributed to any quantitative comparison, value, measurement, or other representation. These terms are utilized herein to represent the degree by which a quantitative representation may vary from a stated reference without resulting in a change in the basic function of the subject matter at issue. The terms “fore” and “aft” used herein refer to directions that are different from one another. For example, the forward direction of the figure and the rearward direction of the figure.

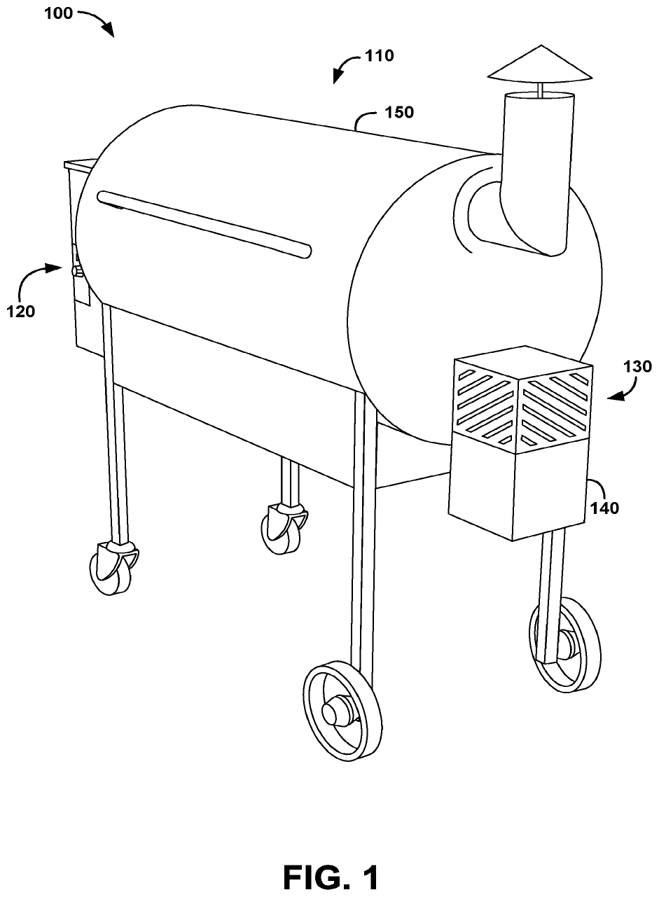

FIG. 1 shows a perspective view illustrating a fluid containment system 100 according to a preferred embodiment of the present invention. Fluid containment system 100 comprises an outdoor cooking device 110 and enclosure 140, as shown. Outdoor cooking device 110 preferably comprises a device to cook food, preferably a grill, preferably a wood pellet grill, as shown. Upon reading the teachings of this specification, those with ordinary skill in the art will now appreciate that, under appropriate circumstances, considering such issues as future technologies, cooking methods, etc., other outdoor cooking devices, such as, for example, grills, sun ovens, dehydrators, curing ovens, stoves, etc., may suffice.

Outdoor cooking device 110 preferably comprises a cooking enclosure 150, cooking controls 120 and at least one drain 130, as shown. In use, outdoor cooking device 110 cook food located within cooking enclosure 150. Controls 120 set levels of cooking and control the cooking environment within the cooking enclosure 150. As the food cooks, liquids drip from the food and collect in or near the bottom of cooking enclosure 150. In foods containing fats, the liquids primarily comprise grease. The liquids and/or ash or other cooking discharge are collected drain out of cooking enclosure 150 through drain 130.

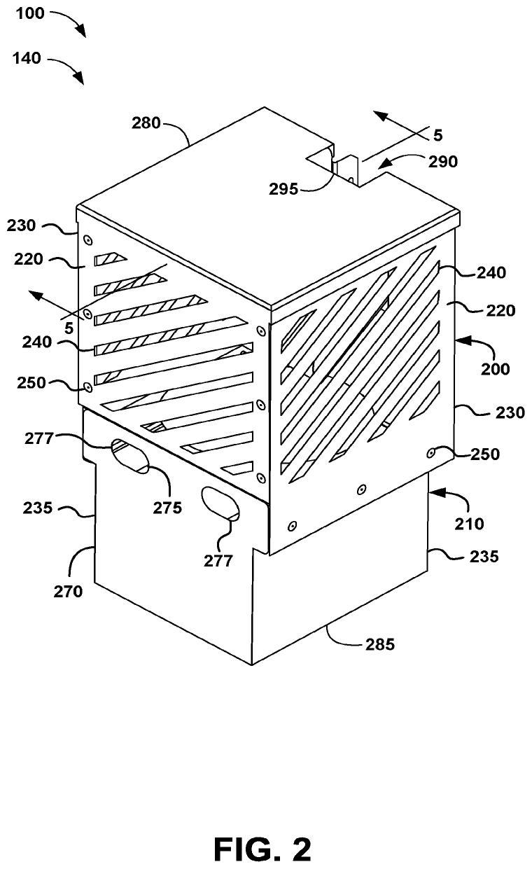

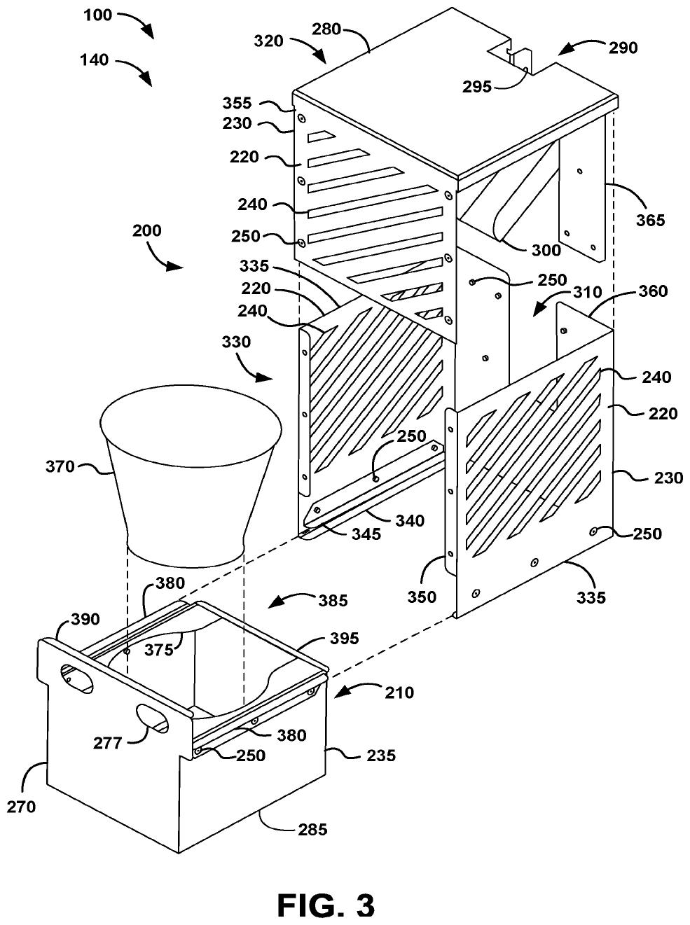

FIG. 2 shows a perspective view, illustrating enclosure 140 of fluid containment system 100, according to the preferred embodiment of FIG. 1. Enclosure 140 preferably comprises an upper portion 200 and a lower portion 210, as shown. Upper portion 200 and lower portion 210 preferably separate, as best shown in FIG. 3, via a rail system. Upper portion 200 and lower portion 210 are each preferably assembled of constituent parts held together with fasteners 250, as shown. Upon reading the teachings of this specification, those with ordinary skill in the art will now appreciate that, under appropriate circumstances, considering such issues as future technologies, costs, consumer preferences, etc., other assembly means, such as, for example, casting, molding, 3-D printing, combinations thereof, etc., may suffice.

Fasteners 250 preferably comprise rivets, as shown, alternately preferably screws. Upon reading the teachings of this specification, those with ordinary skill in the art will now appreciate that, under appropriate circumstances, considering such issues as future technologies, manufacturing costs, durability, customer preferences, etc., other fasteners, such as, for example, bolts, adhesives, welds, slot joints, thumb screws, combinations of various fasteners, etc., may suffice.

Upper portion 200 preferably comprises a shell, as shown. The shell preferably comprises four walls 230 and a top 280, as shown. At least one wall 230 preferably comprises at least one ventilation panel 220, preferably at least two walls 230, preferably at least three walls 230, as shown. Ventilation panel 220 preferably allows air circulation through upper portion 200, as shown. The air circulation helps to cool the liquids in enclosure 140. Ventilation panel 220 preferably comprises at least one vent 240, preferably at least one opening in ventilation panel 220, preferably at least one slot opening, preferably at least one diagonal slot opening, as shown. Upon reading the teachings of this specification, those with ordinary skill in the art will now appreciate that, under appropriate circumstances, considering such issues as future technologies, manufacturing methods, costs, etc., other ventilation panels, such as, for example, circular openings, wavy opening, vertical openings, horizontal openings, splatter screens, perforations, angled perforations, etc., may suffice.

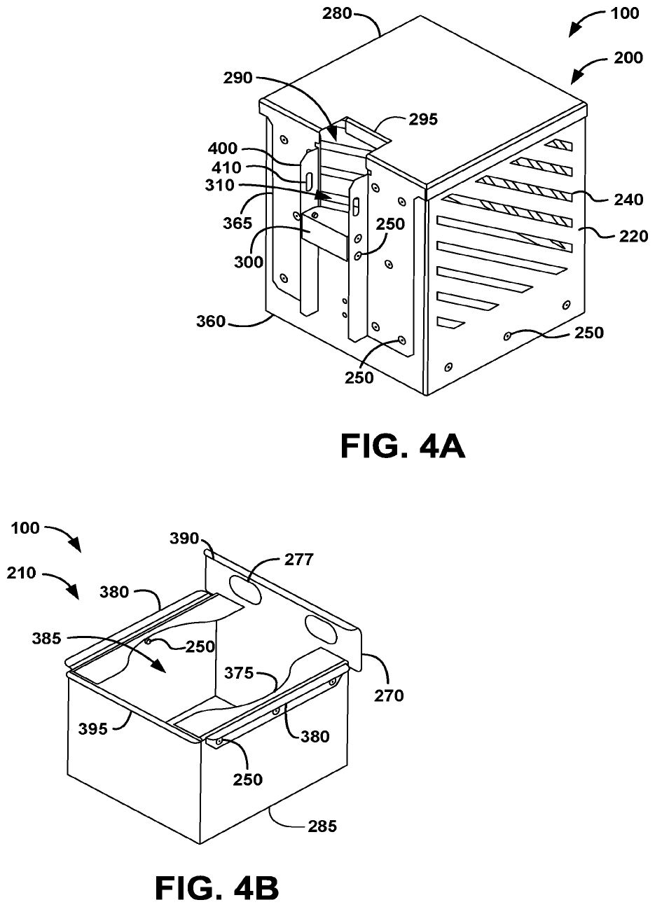

Upper portion 200 further comprises at least one drain receiver 290, as shown. Drain receiver 290 preferably comprises at least one opening, as shown. Opening comprises at least one top notch 295, as shown, and at least one back notch 310 (see FIG. 4). Drain receiver 290 preferably receives drain 130 of outdoor cooking device 110, as shown, allowing passage of the liquids into enclosure 140. Drain receiver 290 preferably is shaped and sized to at least receive drain 130, as shown, at a given angle, preferably at a plurality of angles, preferably a plurality of angles from horizontal to vertically downward. Top notch 295 preferably comprises a squared geometry, as shown, accommodating a drain geometry of drain 130 which is squared and extends at an angle such as to require passage, at least in part, through top 280.

Lower portion 210 preferably comprises a container, as shown. The container comprises a bottom 285 and four walls 235, as shown (at least embodying herein walls surrounding said at least one receptacle). The container is preferably watertight, as shown.

Walls 235 and bottom 285 preferably are sealed at intersections together, as shown, preferably welded. Upon reading the teachings of this specification, those with ordinary skill in the art will now appreciate that, under appropriate circumstances, considering such issues as future technologies, manufacturing methods costs, etc., other watertight arrangements, such as, for example, coatings, liners, adhesives, etc., may suffice.

A front wall 270 of walls 235 of lower portion 210 preferably comprises at least one handle 275, preferably at least one finger-hole 277, preferably two finger-holes 277, as shown. Upon reading the teachings of this specification, those with ordinary skill in the art will now appreciate that, under appropriate circumstances, considering such issues as future technologies, costs, etc., other handles, such as, for example, knobs, grips, protrusions, indentations, rods, flanges, etc., may suffice.

FIG. 3 shows an exploded view of the enclosure of the fluid containment system according shown in FIG. 2. FIG. 4A shows a perspective view, illustrating an upper portion of the enclosure, shown in FIG. 2. FIG. 4B shows a perspective view, illustrating a lower portion of the enclosure.

The shell of upper portion 200 preferably further comprises two pieces assembled with fasteners 250, a first piece 330 and a second piece 320, as shown in FIG. 3. Upon reading the teachings of this specification, those with ordinary skill in the art will now appreciate that, under appropriate circumstances, considering such issues as manufacturing costs, future technologies, etc., other arrangements of construction, such as, for example, separate pieces for each side, single piece construction, etc., may suffice.

First piece 330 preferably comprises three walls 230, as shown in FIG. 3. Three walls 230 preferably comprise back wall 360 and two side walls 335, as shown in FIG. 3. Back wall 360 preferably comprises back notch 310, as shown in FIG. 3. Back notch 310 preferably comprises a rectangular notch from a top of the back wall 360 toward a center of back wall 360, preferably past the center of back wall 360, as shown in FIG. 3. Upon reading the teachings of this specification, those with ordinary skill in the art will now appreciate that, under appropriate circumstances, considering such issues as future technologies, costs, etc., other cutouts, such as, for example, circular punch outs, slot pass throughs, collars, etc., may suffice.

Second piece 320 preferably comprises top 280 and two walls 230, as shown in FIG. 3. Two walls 230 preferably comprise a back wall 365 and a front wall 355. Back wall 365 and back wall 360 preferably combine and overlap, as shown in FIGS. 3-4A. Back wall 365 preferably comprises two strips located to each side of back notch 310, as shown in FIG. 3. Upon reading the teachings of this specification, those with ordinary skill in the art will now appreciate that, under appropriate circumstances, considering such issues as future technologies, costs, mounting preferences, etc., other back wall structures, such as, for example, single layered walls, walls adjoining side walls, removably mounted walls, etc., may suffice.

Back wall 365 preferably further comprises two mount flanges 400, as shown in FIG. 4A. Mount flanges 400 preferably extend from back wall 365, as shown in FIG. 4A. Mount flanges 400 preferably are located on each side of back notch 310, as shown in FIG. 4A. Mount flanges 400 preferably comprise drain mounts 410, as shown in FIG. 4A, permitting enclosure 140 to mount on drain 130. Upon reading the teachings of this specification, those with ordinary skill in the art will now appreciate that, under appropriate circumstances, considering such issues as future technologies, costs, etc., other mounts, such as, for example, hanging mounts, collar mounts, flush mounts, mounts to cooking enclosure, bracket mounts, etc., may suffice.

Drain mounts 410 preferably comprise mounting holes, as shown in FIG. 4A. Upon reading the teachings of this specification, those with ordinary skill in the art will now appreciate that, under appropriate circumstances, considering such issues as future technologies, costs, etc., other mounts, such as, for example, plates, hooks, bayonet slots, rods, thumb screws, bolts, etc., may suffice.

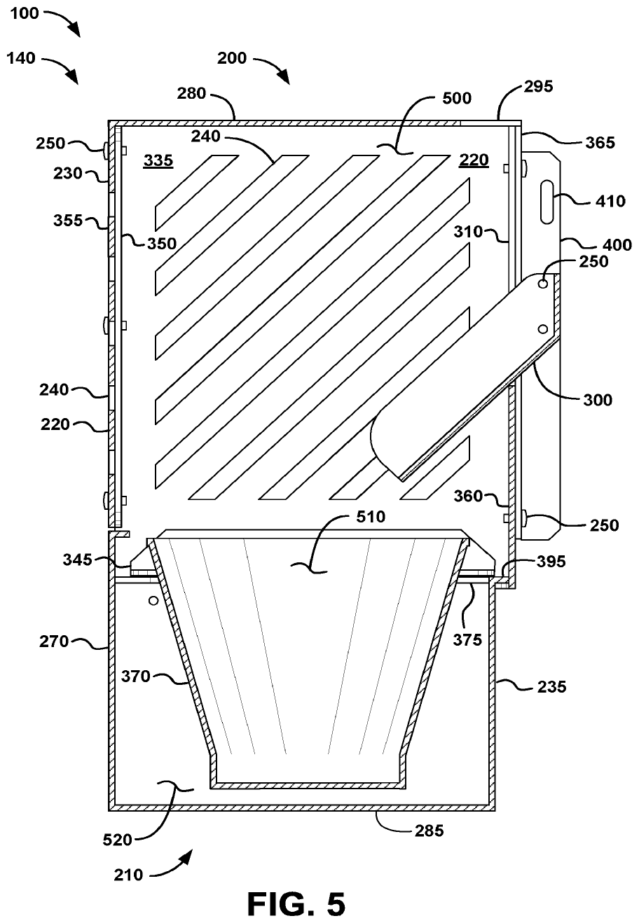

Back notch 310 preferably accommodates a drainage channel 300, as shown in FIG. 3, and drain 130. Drainage channel 300 preferably mounts between the two strips of back wall 365, as shown in FIGS. 3-4A. Drainage channel 300 preferably mounts to mount flanges 400 using fasteners 250, as shown in FIG. 4A. Drainage channel 300 preferably passes through back notch 310, as shown in FIG. 4A. Drainage channel 300 directs the fluids from drain 130 to a center portion of upper portion 200 (see FIG. 5). Upon reading the teachings of this specification, those with ordinary skill in the art will now appreciate that, under appropriate circumstances, considering such issues as future technologies, costs, etc., other drainage channel mounts, such as, for example, bracket mounts, flush mounts, collar mounts, brace mounts, etc., may suffice.

First piece 330 preferably further comprises at least one rail slot on each side wall 335 of walls 230, as shown in FIG. 3. The at least one rail slot preferably forms from rail flange 340 and protrusion flange 345, as shown in FIG. 3. Rail flange 340 preferably extends perpendicular to a bottom edge of side wall 335, as shown in FIG. 3. Protrusion flange 345 preferably mounts to side wall 335, as shown in FIG. 3. Protrusion flange 345 preferably is located above rail flange 345 leaving the at least one rail slot, as shown in FIG. 3. Rail flange 345 preferably extends from about back wall 360 the width of side wall 335, as shown in FIG. 3. Protrusion flange 345 preferably is centered along length of rail flange 345, as shown in FIG. 3. Protrusion flange 345 preferably is shorter than rail flange 345, as shown in FIG. 3.

Side walls 335 of first piece 330 preferably comprise at least one front flange 350, as shown in FIG. 3. Front flange 350 preferably assembles to front wall 355 with fasteners 250, as shown in FIG. 3. Upon reading the teachings of this specification, those with ordinary skill in the art will now appreciate that, under appropriate circumstances, considering such issues as manufacturing costs, future technologies, etc., other arrangements of construction, such as, for example, separate pieces for each side, single piece construction, etc., may suffice.

Lower portion 210 preferably further comprises at least one rail 380, as shown in FIG. 3. Rail 380 preferably mounts to each side of lower portion 210 corresponding to the at least one rail slot of upper portion 200, as shown in FIG. 3. Rail 380 preferably slides into and out of the at least one rail slot, as shown in FIG. 3. Upon reading the teachings of this specification, those with ordinary skill in the art will now appreciate that, under appropriate circumstances, considering such issues as future technologies, costs, etc., other removable interconnections between upper portion and lower portion, such as, for example, bayonet locking, roller slides, screw mounting, door openings, etc., may suffice.

Lower portion 210 preferably further comprises at least one back flange 395, as shown in FIG. 3. Back flange 395 extends from a back side of lower portion 210, which is inserted first into upper portion 200, as shown in FIG. 3. Back flange 395 preferably stops lower portion 210 when slid on rail 380 to a fully inserted state (see FIG. 5). Upon reading the teachings of this specification, those with ordinary skill in the art will now appreciate that, under appropriate circumstances, considering such issues as future technologies, costs, etc., other stops, such as, for example, protrusions, screws, stops mounted on back wall, posts, notches, etc., may suffice.

Lower portion 210 preferably further comprises at least one receptacle support 375, as shown in FIG. 3. Receptacle support 375 preferably suspends a receptacle 370 in lower portion 210, as shown in FIG. 3 (at least embodying herein at least one receptacle support structured and arranged to support said at least one receptacle). Receptacle support 375 preferably comprises at least one flange, preferably at least one curved flange, as shown in FIG. 3. Receptacle support 375 preferably extends from a top of a side wall of walls 235 inward toward a center of lower portion 210, as shown in FIG. 3. Receptacle support 375 preferably creates an opening 385 at a top of lower portion 210, preferably a shaped opening, preferably shaped to at least partially match a side of receptacle 370, as shown in FIG. 3. Upon reading the teachings of this specification, those with ordinary skill in the art will now appreciate that, under appropriate circumstances, considering such issues as future technologies, costs, etc., other receptacle supports, such as, for example, wire frames, rings, braces, posts offset platforms, etc., may suffice.

Receptacle 370 preferably comprises a bucket, alternately preferably a bucket liner, as shown in FIG. 3. Upon reading the teachings of this specification, those with ordinary skill in the art will now appreciate that, under appropriate circumstances, considering such issues as future technologies, costs, etc., other receptacles, such as, for example, canisters, cups, absorbent materials, atomizers, binders, etc., may suffice.

Receptacle 370 preferably is centered by receptacle support 375 inside lower portion 210 (see FIG. 5). When lower portion 210 is fully inserted into upper portion 200, drainage channel 300 preferably is over receptacle 370 (see FIG. 5). The fluids running down drainage channel 300 preferably drop off drainage channel 300 into receptacle 370. Front wall 270 of lower portion 210 preferably extends above receptacle support 375, as shown in FIGS. 3 and 4B. Finger-holes 277 preferably are above receptacle support 375, as shown in FIGS. 3 and 4B. Front wall 270 preferably comprises at least one top flange 390, as shown in FIG. 3. Top flange 390 preferably extends perpendicularly inward from a top of front wall 270, as shown in FIG. 3.

FIG. 5 shows the sectional view 5-5 of FIG. 2. Upper portion 200 preferably comprises an upper cavity 500 inside the shell of upper portion 200, as shown. Lower portion 210 preferably comprises a lower cavity 520, as shown. Receptacle 370 (at least embodying herein at least one receptacle structured and arranged to receive and collect fluid draining from the outdoor cooking device generated by food cooking within a cooking enclosure of the outdoor cooking device) preferably comprises a receptacle cavity 510, as shown. The liquids from drain 130 enter enclosure 140 and run down drainage channel 300. The liquids run off drainage channel 300 and enter receptacle cavity 510. Heat from the liquids rises into upper cavity 500. Air flows through ventilation panel 220 carrying the heat from upper cavity 500 to an outdoor environment to which enclosure 140 is preferably directly exposed (at least herein embodying wherein said enclosure is directly exposed to the outdoor environment while mounted on the outdoor cooking device).

Lower cavity 520 creates an insulation between walls of receptacle 370 and walls 235 of lower portion, as shown (at least herein embodying wherein said enclosure comprises at least one insulation layer between said receptacle and said walls). The insulation preferably comprises an air gap in lower cavity 520, as shown. Therefore, heat is dissipated from the liquids preferably without heating enclosure 140 enough to cause burns through casual contact with enclosure 140. Upon reading the teachings of this specification, those with ordinary skill in the art will now appreciate that, under appropriate circumstances, considering such issues as future technologies, costs, etc., other insulations, such as, for example, water, foams, vacuum layers, ceramics, sand, etc., may suffice.

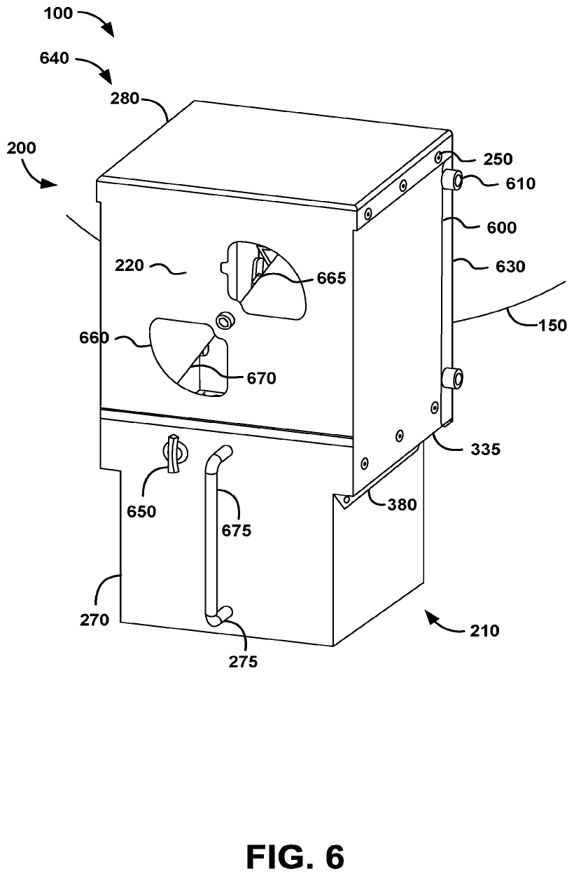

FIG. 6 shows a perspective view illustrating a fluid containment system 100 according to another aspect of the present invention. Fluid containment system 100 alternately preferably comprises enclosure 640, as shown. Although many of the elements of enclosure 640 are repeated from enclosure 140, as shown in FIG. 6, enclosure 640 utilizes bar handle 675 instead of finger holes 277 for handle 275 and back wall 630 instead of back wall 360 and back wall 365 on upper portion 200 and vent 660 instead of vent 240, as shown.

Lower portion 210 preferably comprises front wall 270, as shown. Front wall 270 preferably comprises handle 275, as shown. Handle 275 preferably comprises bar handle 675, as shown. Bar handle 675 preferably extends from front wall 270, as shown, and provides a bar to grasp with a hand. Upon reading the teachings of this specification, those with ordinary skill in the art will now appreciate that, under appropriate circumstances, considering such issues as future technologies, costs, etc., other handles, such as, for example, knobs, grips, protrusions, indentations, rods, flanges, etc., may suffice.

Further, front wall 270 preferably comprises at least one latching mechanism 650, as shown. Latching mechanism 650 preferably comprises a turning latch, as shown, comprising a cam inside enclosure 640. Latching mechanism 650 preferably latches lower portion 210 to upper portion 200, as shown, such that to access receptacle 270 latching mechanism must be unlatched prior to pulling handle 275 to disengage lower portion 210 from upper portion 200. Upon reading the teachings of this specification, those with ordinary skill in the art will now appreciate that, under appropriate circumstances, considering such issues as future technologies, costs, etc., other latching mechanisms, such as, for example, locks, bolts, chains, spring-loaded throws, etc., may suffice.

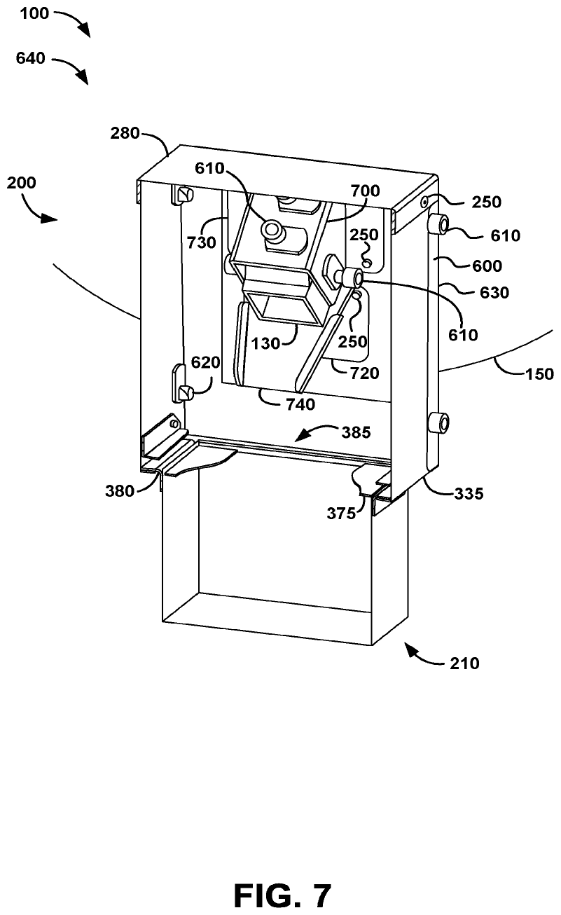

Back wall 630 of upper portion 200 preferably comprises at least one side flange 600, as shown. Side flange 600 preferably wraps around each side wall 335, as shown. Side flange 600 preferably assembles together with side wall 335 using release fasteners 610, as shown. Back wall 630 preferably mounts close to cooking enclosure 150, as shown. Back wall 630 preferably allows passage of drain 130 into enclosure 640, as shown in FIG. 7.

Release fasteners 610 preferably comprise thumb actuatable fasteners, preferably thumb screws, as shown. Upon reading the teachings of this specification, those with ordinary skill in the art will now appreciate that, under appropriate circumstances, considering such issues as future technologies, costs, etc., other releasable fasteners, such as, for example, wing nuts, cam latches, bayonet slots, etc., may suffice.

Ventilation panel 220 preferably comprises vent 660, as shown. Vent 660 preferably comprises an adjustable vent, as shown. Vent 660 preferably comprises at least one butterfly opening, as shown. Upon reading the teachings of this specification, those with ordinary skill in the art will now appreciate that, under appropriate circumstances, considering such issues as future technology, cost, etc., other vent openings, such as, for example, slots, holes, perforations, etc., may suffice.

Vent 660 preferably comprises at least one closure 670 to close off vent 660, as shown. Closure 670 preferably comprises at least one damper. Closure 670 preferably comprises tab 665, as shown. Closure 670 preferably rotates about a pivot adjusting the butterfly opening between fully open and fully closed, permitting the selection of the amount of ventilation to allow enclosure 640, as shown. Upon reading the teachings of this specification, those with ordinary skill in the art will now appreciate that, under appropriate circumstances, considering such issues as future technologies, cost, etc., other closures, such as, for example, sliding closures, door closures, flap closures, etc., may suffice.

In use, vent 660 provides for fire safety. When outdoor cooking device 110 is at higher temperatures, the air coming from the drain 130 may reach ignition temperatures for the fluids contained in receptacle 370. To prevent a fire condition, vent 660 preferably may be closed to minimize available oxygen within enclosure 640.

FIG. 7 shows a perspective cutaway view, illustrating an interior of the enclosure of the fluid containment system shown in FIG. 6. Although many of the elements of enclosure 640 are repeated from enclosure 140, as shown in FIG. 7, enclosure 640 utilizes collar mount 700 instead of mount flanges 400 to mount upper portion 200 to drain 130. Back wall 630 preferably separates from the remainder of upper portion 200 allowing mounting of back wall 630 to drain 130, as shown (at least embodying herein at least one mount structured and arranged to mount said enclosure on the outdoor cooking device). Separation of back wall 630 is preferably achieved via release of release fasteners 610 from release nuts 620, as shown. Back wall 630 preferably further comprises at least one collar mount 700, as shown. Collar mount 700 preferably attaches to back wall 630 with fasteners 250, as shown. Collar mount 700 preferably surrounds drain 130, as shown, as a collar. Collar mount 700 preferably comprises release fasteners 610, as shown. Release fasteners 610 preferably tighten onto drain 130, mounting back wall 630 onto drain 130, as shown. Upon reading the teachings of this specification, those with ordinary skill in the art will now appreciate that, under appropriate circumstances, considering such issues as future technologies, cost, etc., other mounting mechanisms, such as, for example, clamps, annular rings, pins, hooks, etc., may suffice.

Drain 130 preferably comprises a tube, preferably a square tube, as shown. Upon reading the teachings of this specification, those with ordinary skill in the art will now appreciate that, under appropriate circumstances, considering such issues as future technologies, costs, etc., other drain shapes, such as, for example, circular, V-shaped, rectangular, etc., may suffice. Back wall 630 preferably further comprises drainage channel 740, as shown. Drainage channel 740 preferably serves as an alternately preferably version of drainage channel 300, as shown. Drainage channel 740 preferably comprises a wedge shape, as shown.

Drainage channel 740 preferably mounts with bracket 720 onto back wall 630 using fasteners 250, as shown. Upon reading the teachings of this specification, those with ordinary skill in the art will now appreciate that, under appropriate circumstances, considering such issues as future technologies, costs, etc., other drainage channels, such as, for example, tubes, semicircular channels, V-shaped channels, etc., may suffice.

It is understood that while enclosure 640 is presented as an alternative configuration from enclosure 140, the differing elements presented as parts of enclosure 640 and enclosure 140, respectively, are capable of interchangeability between enclosure 640 and enclosure 140 with like elements.

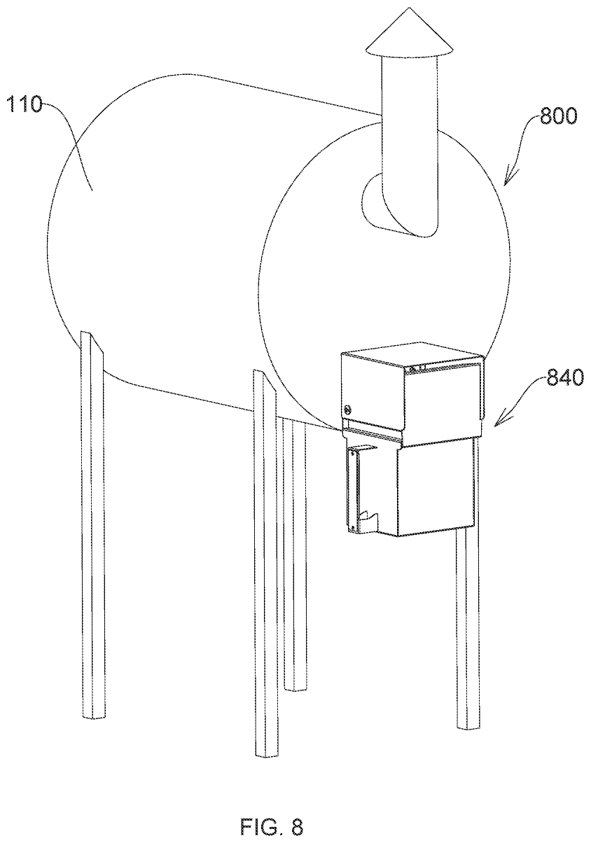

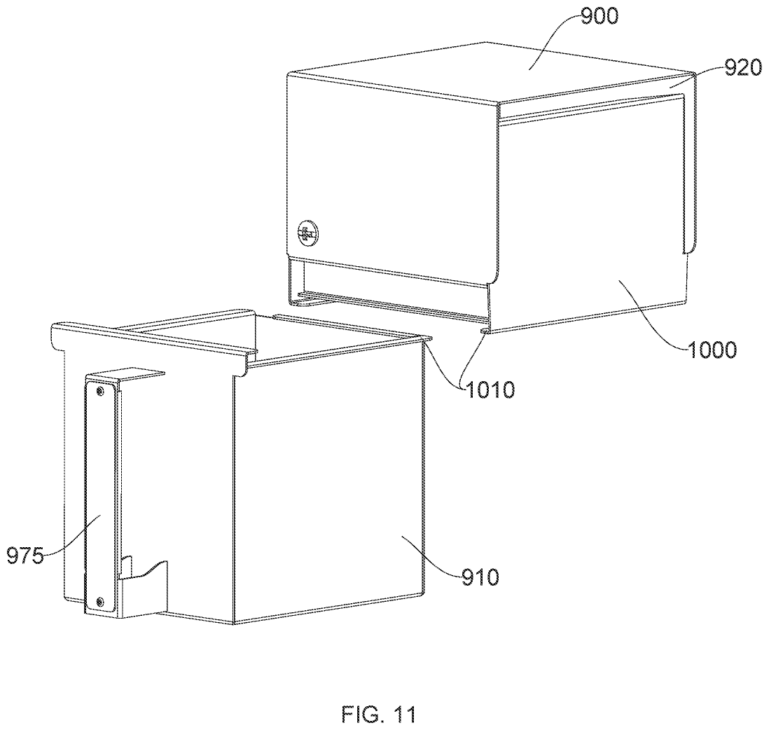

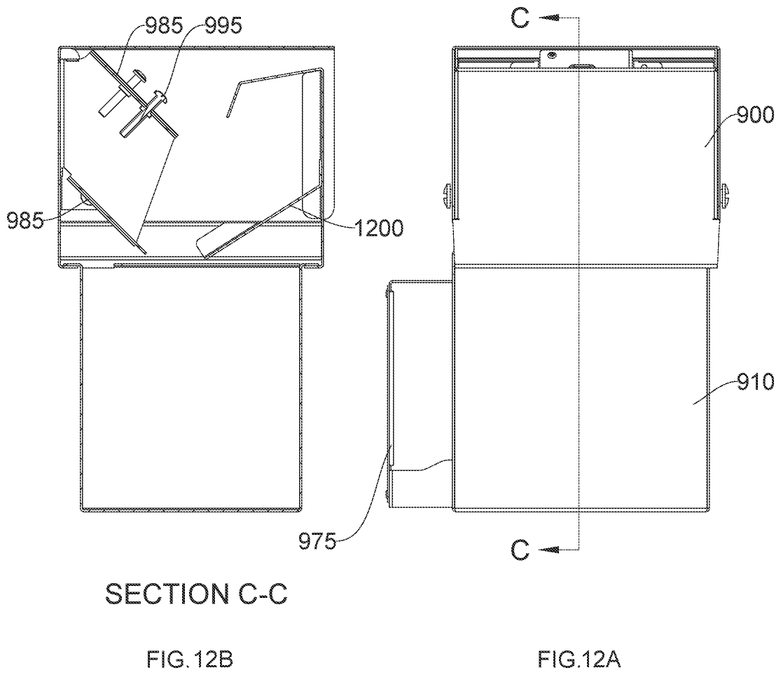

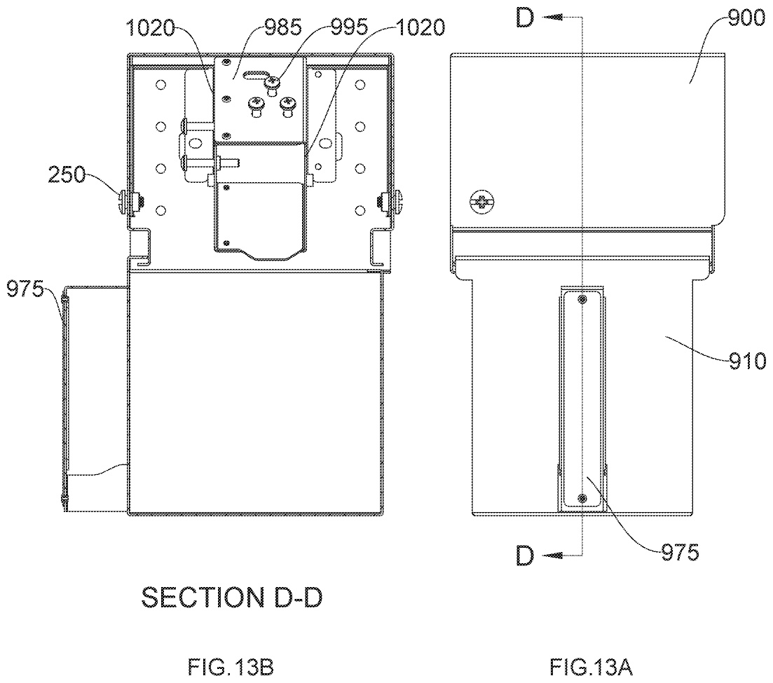

In the fluid containment system as shown in FIGS. 8-13B, the system 800 may comprise an enclosure 840 which may comprise an upper portion 900 and a lower portion 910. As described previously, one or more fasteners 250 such as by non-limiting example, a screw or a rivet may be used to securely hold the components of the upper portion 900 and lower portion 910 securely together. In cooking environments, the upper portion 900 is detachably coupled to the lower portion 910 such as by one or more rails 1010 on either the upper 900 or lower portion 910 configured to meet with one or more rails 1010 of the lower portion 910 such that the upper portion 900 and lower portion 910 are slidably coupled for ease and safe removal of the lower portion 910 form the upper portion 900. A fluid receptacle such as an interior bucket or a liner (not shown) may be removed from the lower portion 910 of the enclosure and emptied after receiving fluid from the drain 130 of an outdoor cooking device 110. The lower portion 910 is also configured to receive the fluid directly and, as such, would not include a receptacle or a receptacle support. Additionally, it is contemplated that the lower portion 910 may comprise a handle 975 for ease of use. In some implementations, one or more of the fasteners 250 may further comprise a locking mechanism configured to allow the lower portion 910 of the enclosure to remain in a locked position when in use such that a user cannot freely slide the lower portion 910 along the rails 1010 when the outdoor cooking device 110 is in use. In some implementations, the locking device may be integral to rather than coupled with the handle 975. In some implementations, the lower portion 910 of the enclosure 840 may comprise a pouring spout (not shown) for ease of emptying cooking discharge from the receptacle within the lower portion 910.

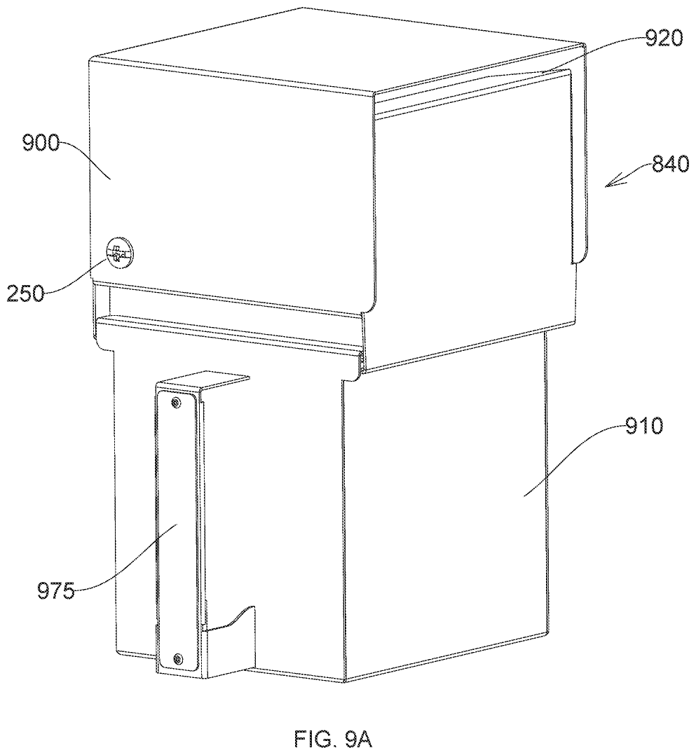

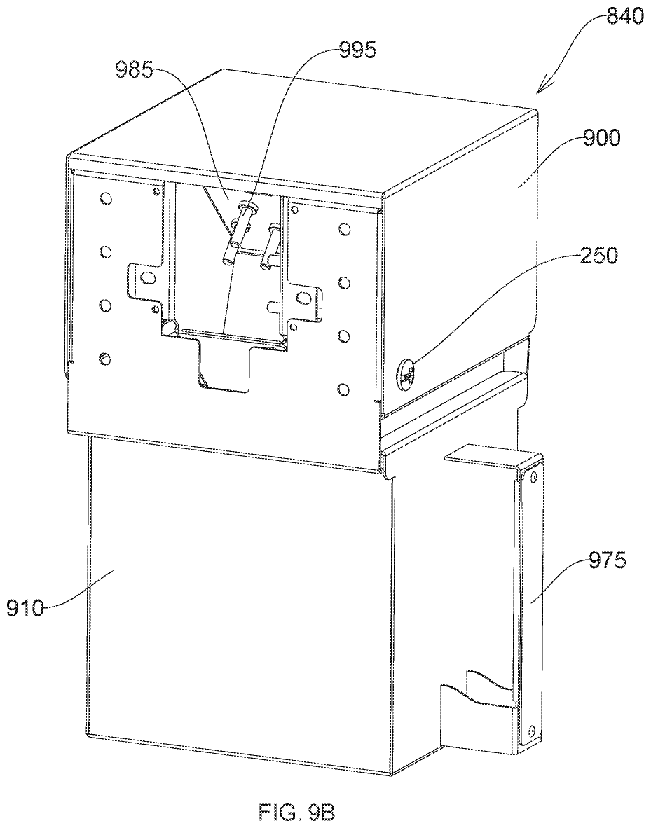

As shown in FIGS. 9B-10, FIG. 12B, and FIG. 13B, the enclosure 840 may comprise an internal mount 985 at least partially within the upper portion 900 of the enclosure 840. The internal mount may be configured to receive a drain 130 of an outdoor cooking device 110, however, it is also contemplated that the outdoor cooking device 110 may be configured with an abbreviated drain structure such that the fluid channel mount walls 1020 of the internal mount 985 form a fluid channel for fluid to pass directly from the outdoor cooking device 110 and into a receptacle such a bucket within the lower portion 910 of the enclosure. It is contemplated that the receptacle may have any appropriate shape such as round, oval, square, rectangular, etc.

The internal mount 985 may comprise a mounting plate base 1030 through which one or more mounting fasteners 995 may pass to secure the internal mount 985 to the outdoor cooking device 110. In some implementations, the mounting plate base 1030 may be integral to or comprise a side panel 1000 of the upper portion 900 of the enclosure 840, however, it is also contemplated that the mounting plate base 1030 is positioned within the upper portion 900 of the enclosure. The internal mount 985 may further comprise one or more fluid channel mount walls 1020 that when mounted in place with one or more mounting fasteners 995 may be configured to allow fluid to pass from the drain 130 of the outdoor cooking device 110 into the enclosure and thus, into the lower portion 910 of the enclosure 840. According to another aspect, the interior of the upper portion of the enclosure may further comprise an auxiliary fluid guide plate 1200 configured to contain collected fluid and funnel the fluid downward into the receptacle of the lower portion of the enclosure 840. The auxiliary fluid guide plate 1200 may also prevent one or more internal parts of the enclosure 840 such as by non-limiting example, the sliding rails 1010 from gathering a buildup of grease or other cooking byproducts. Additionally, the auxiliary fluid guide plate 1200 may also serve to prevent the lower portion 910 of the enclosure 840 from falling when partially pulled to an open position along the one or more rails 1010.

The upper portion 900 of the receptacle may comprise one or more side walls 1000 which may optionally be configured with one or more thermal vents 920 to allow for heat to escape with the outdoor cooking device 110 is in use. While the thermal vent 920 may be of any appropriate size, in some implementations, the thermal vent 920 may be sized to be substantially a same size as the drain 130 of the outdoor cooking device 110 to restrict airflow.

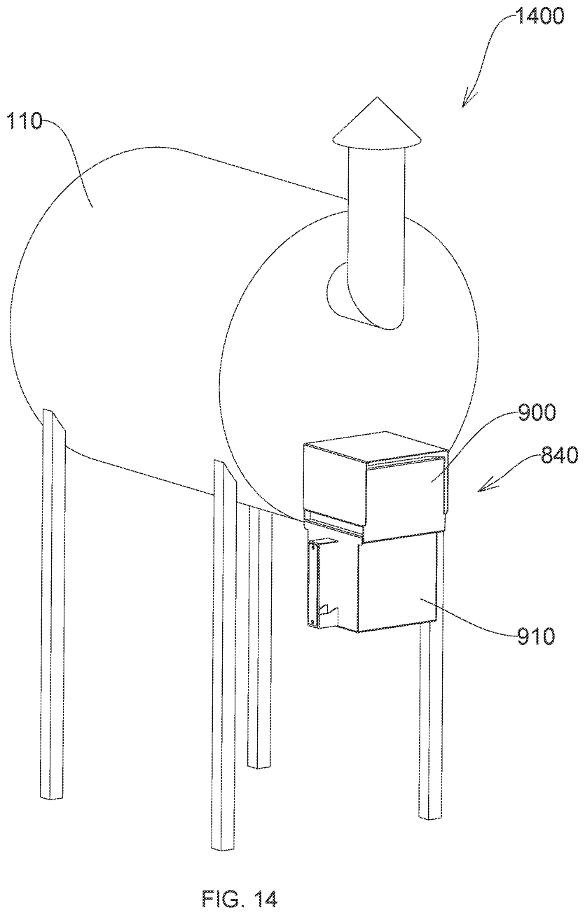

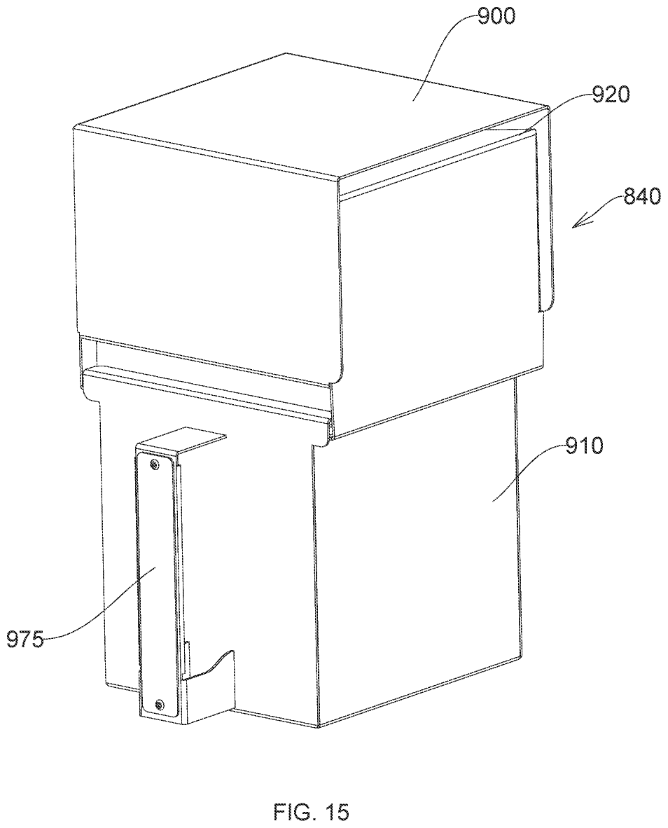

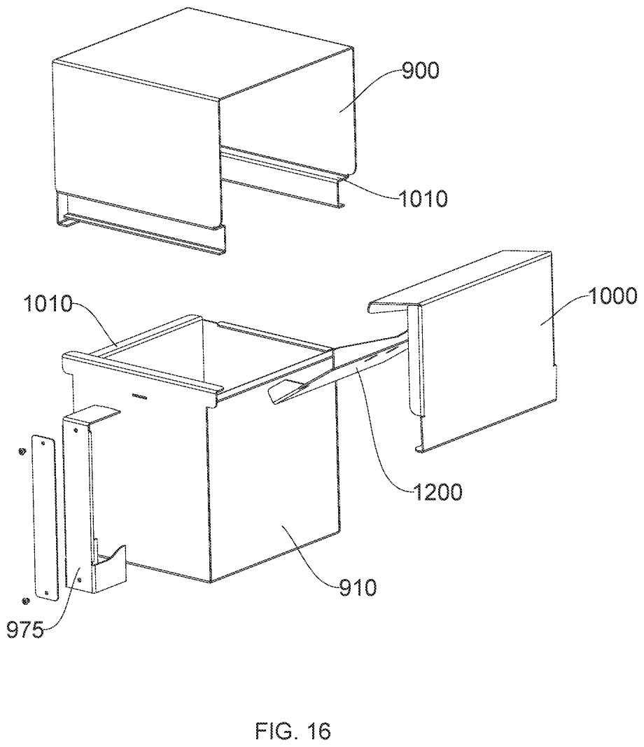

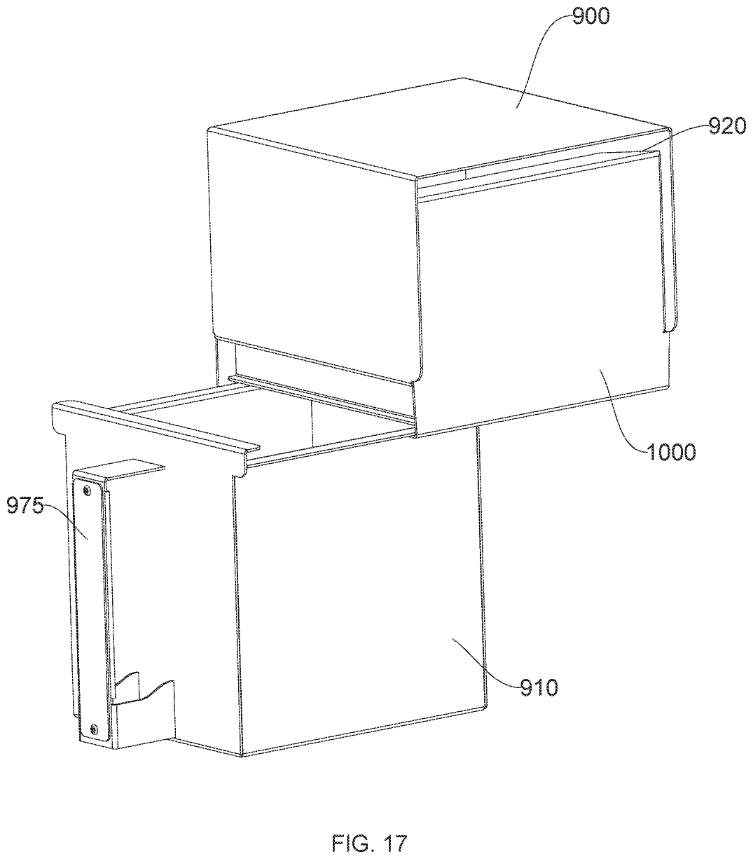

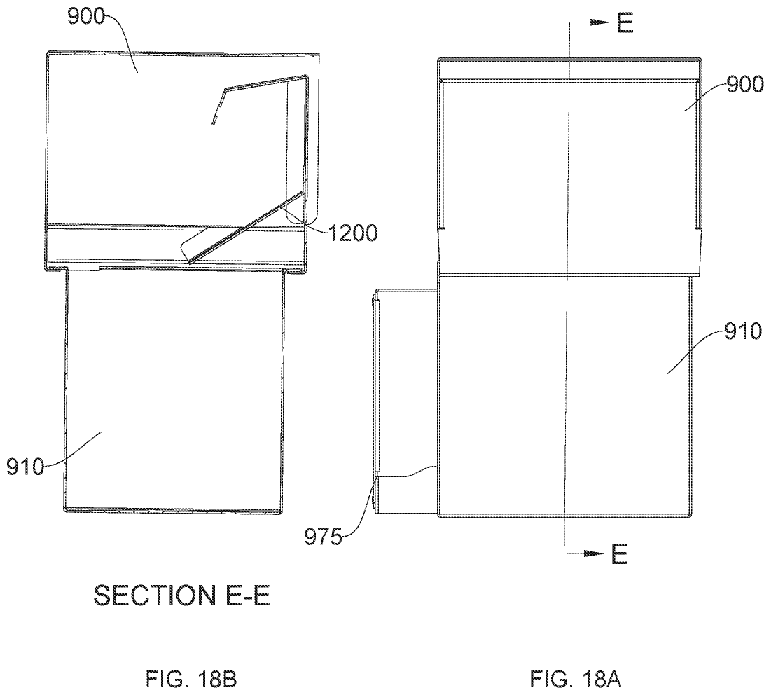

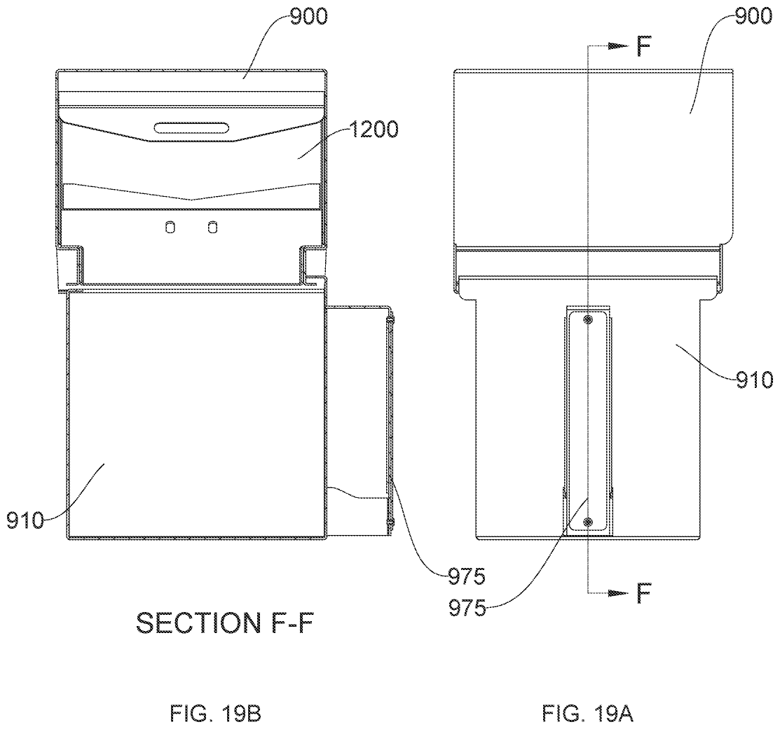

Another aspect of a fluid containment system 1400 is shown in FIGS. 14-19B, it is contemplated that at least a portion of the enclosure 840, shown here as the upper portion 900 of the enclosure is permanently affixed to the outdoor cooking device 110 such as by non-limiting example, by welding the upper portion 900 of the enclosure to the outdoor cooking device 110. It is contemplated that the drain 130 of the outdoor cooking device may extend through an opening in the upper portion 900 of the enclosure 840 or that one or more auxiliary fluid guide plates 1200 may be positioned within the enclosure 840 to guide fluid into a receptacle within the lower portion 910 of the enclosure 840. The auxiliary fluid guide plate 1200 may also prevent one or more internal parts of the enclosure 840 such as by non-limiting example, the sliding rails 1010 from gathering a buildup of grease or other cooking byproducts. Additionally, the auxiliary fluid guide plate 1200 may also serve to prevent the lower portion 910 of the enclosure 840 from falling when partially pulled to an open position along the one or more rails 1010.

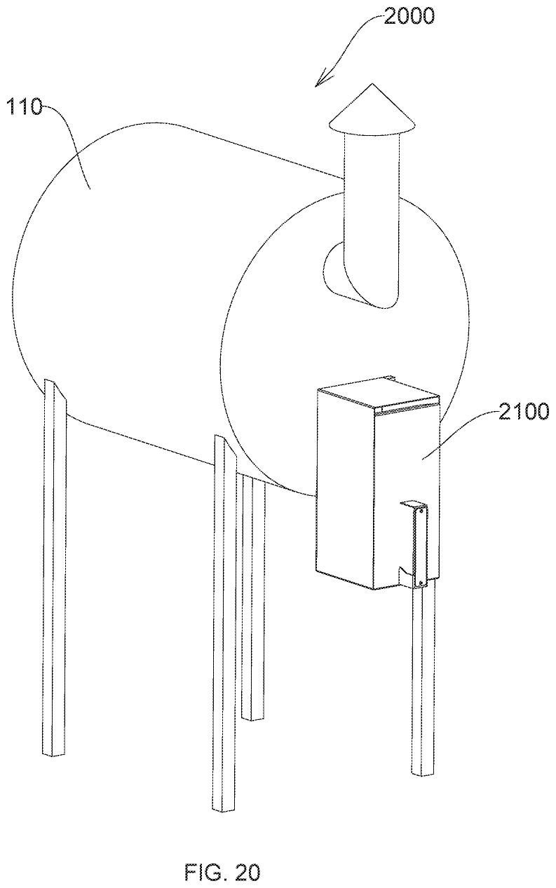

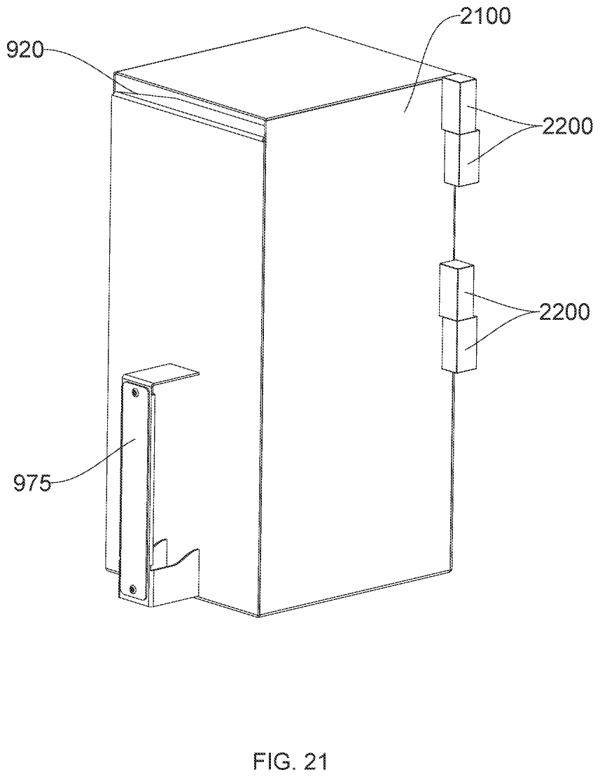

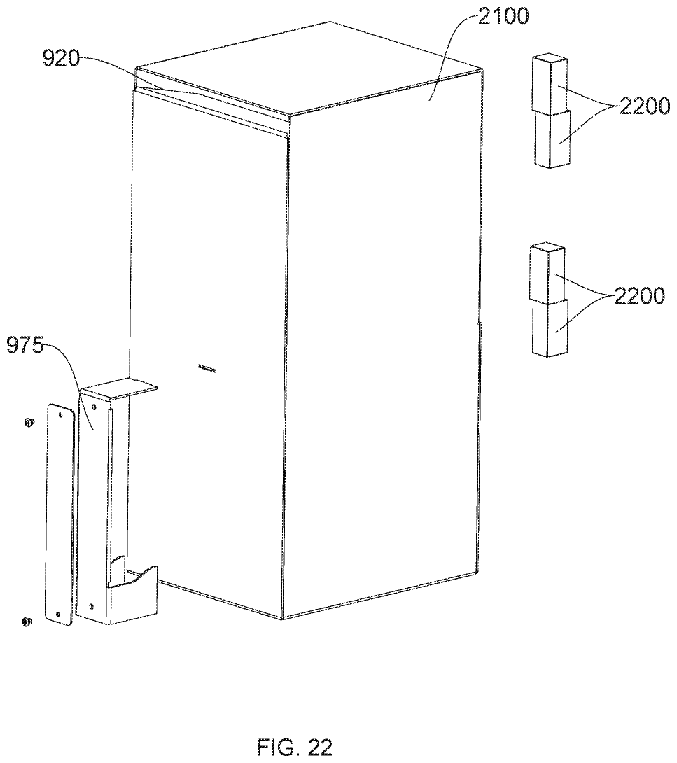

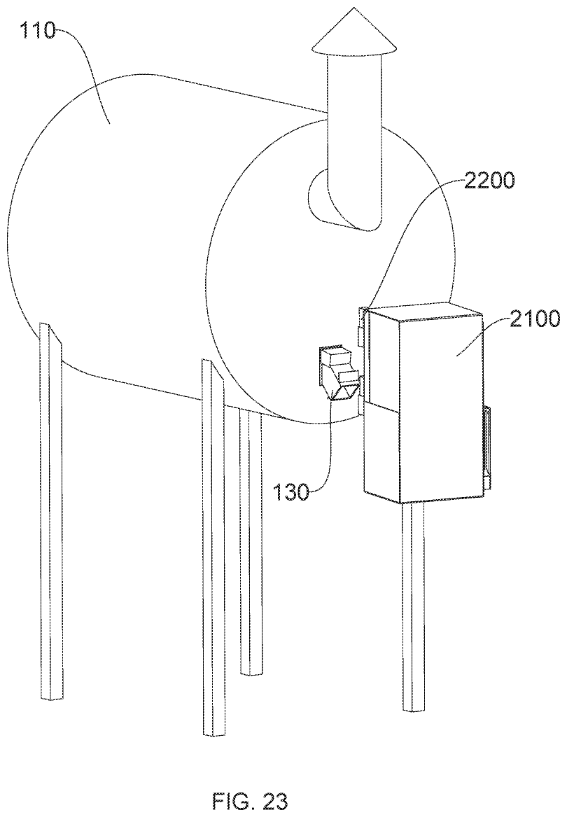

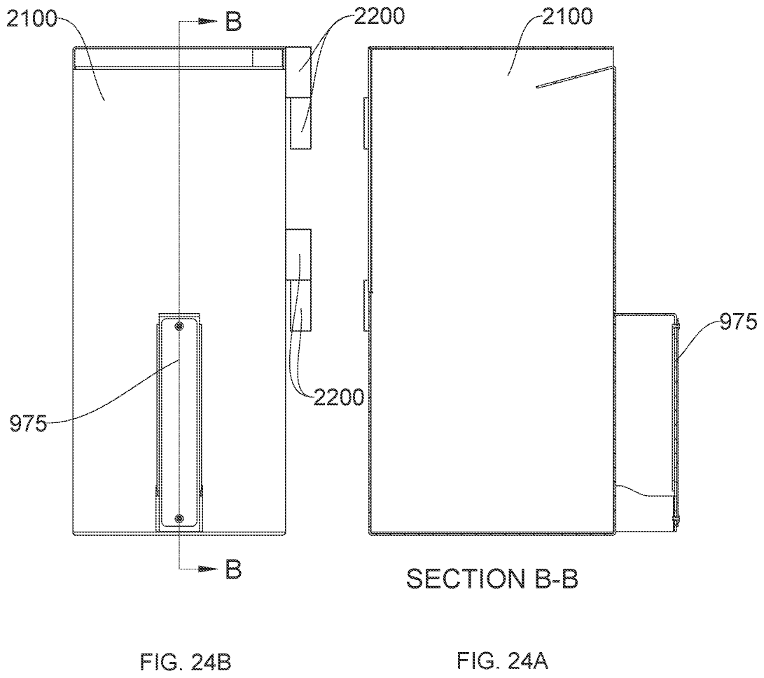

A fluid containment system 2000 is shown in FIGS. 20-24B, according to another aspect of the present invention, the enclosure 2100 may be hingedly coupled to the outdoor cooking device 110 via one or more hinges 2200. When in the open position as shown in FIG. 23, the enclosure 2100 may hingedly swing outward from the outdoor cooking device 110 for ease of emptying the fluid receptacle positioned within the enclosure 2100. In various implementations, the upper portion 900 of the enclosure 2100 may be hingedly coupled to the outdoor cooking device; however, in other implementations, the lower portion 910 may also hingedly couple to the outdoor cooking device 110.

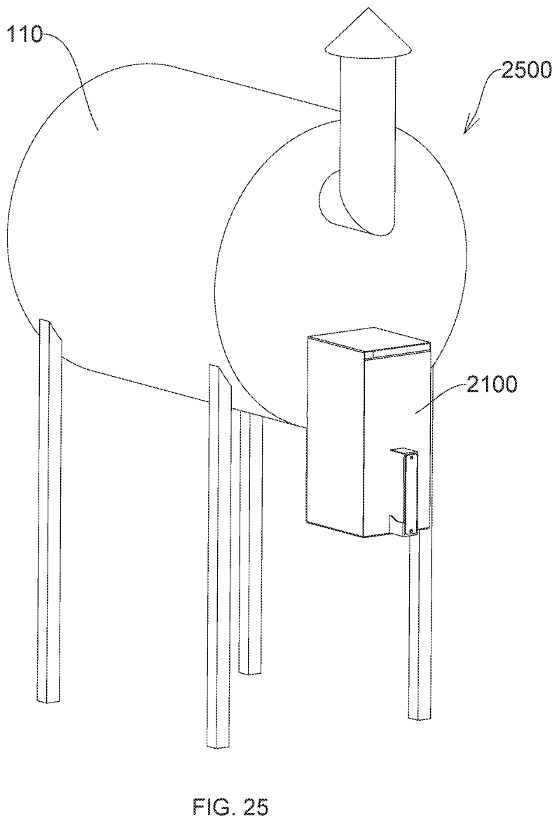

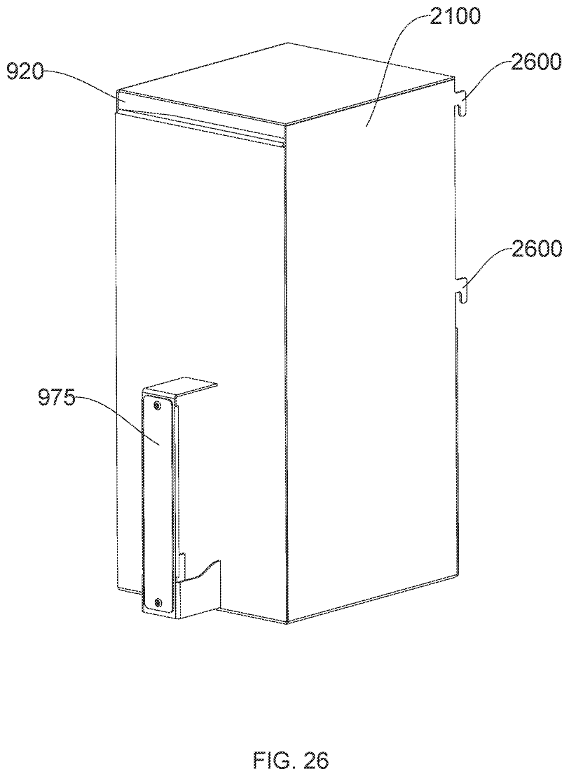

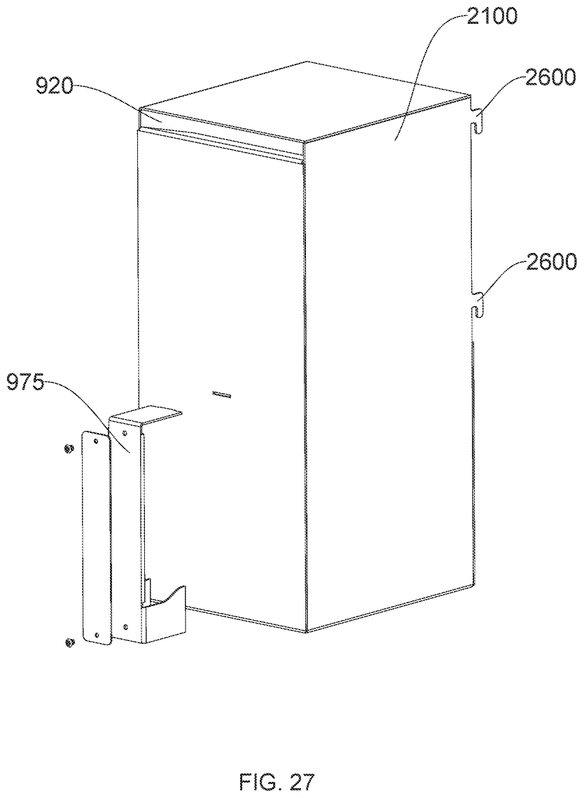

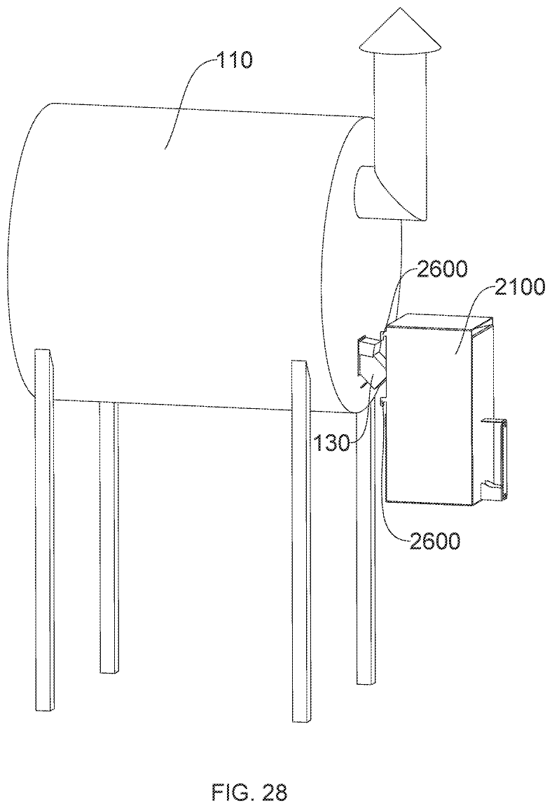

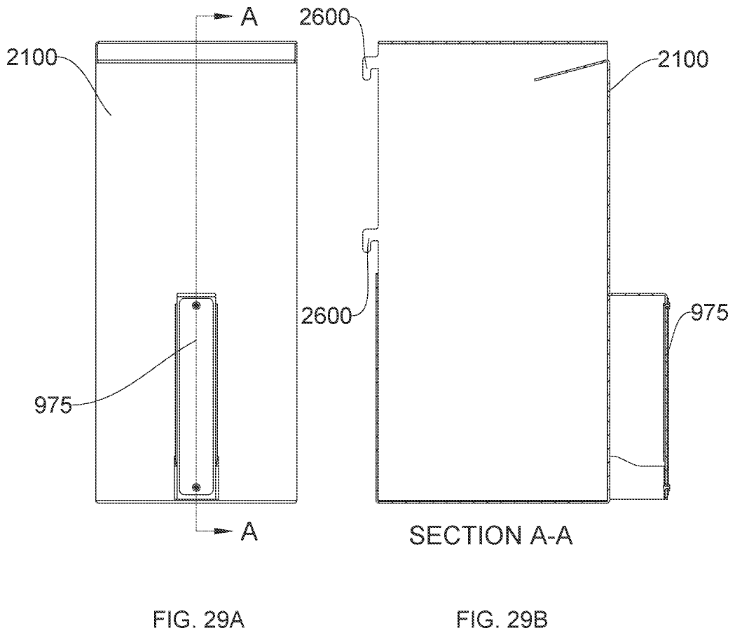

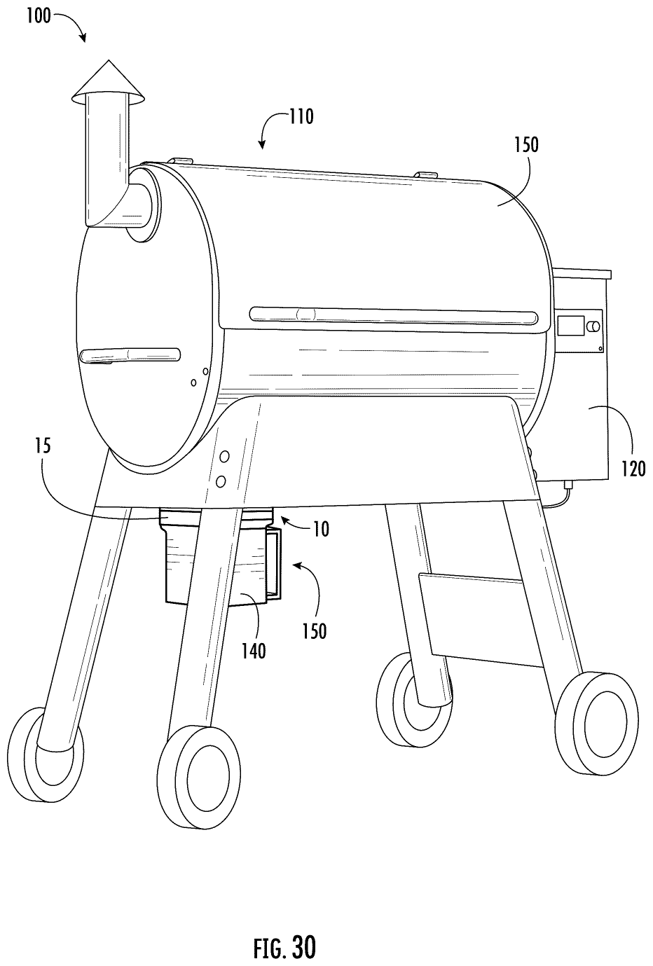

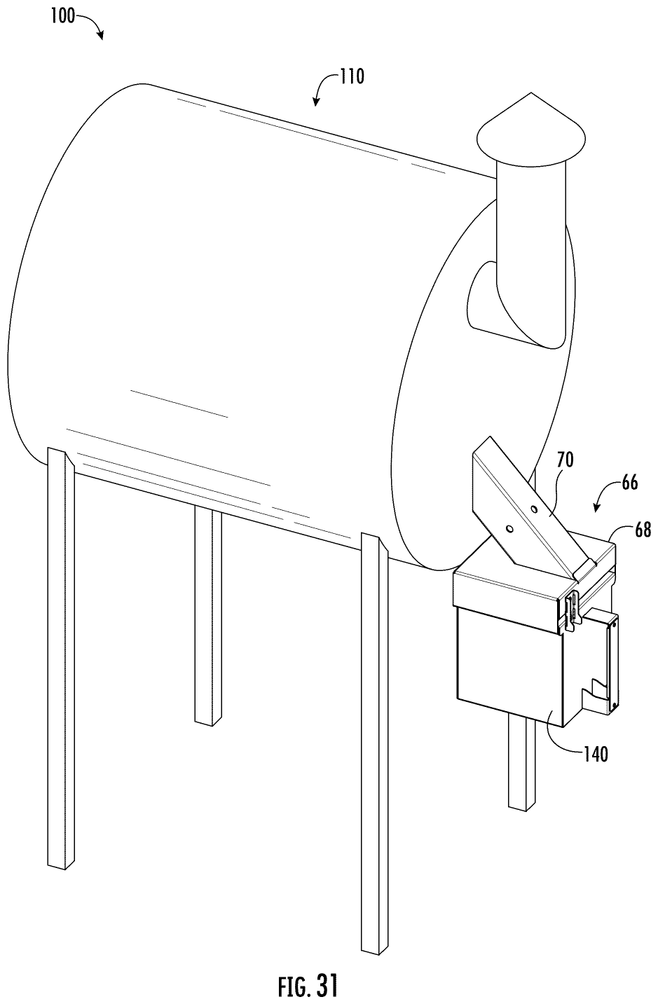

A fluid containment system 2500, according to another aspect, is shown in FIGS. 25-29B, the enclosure may comprise one or more notched mounting brackets 2600 configured to detachably couple the enclosure 2100 to the outdoor cooking device 110. As shown in FIG. 28, the one or more mounting brackets 2600 may be configured to mate with and/or couple with one or more corresponding elements of the outdoor cooking device 110.

While any of the fluid containment systems described herein may comprise an upper portion 900 and a lower portion 910 of the enclosure that may be slidably coupled by one or more rails corresponding to a mating structure on the opposite portion of the enclosure. Alternatively, one or more of the upper portion 900 and the lower portion 910 may be threaded so as to detachably couple the upper portion 900 and the lower portion 910 together. It is also contemplated that any of the embodiments described herein may also be used with and coupled to an outdoor cooking device 110 having a fluid drain 130 positioned on a bottom of the outdoor cooking device 110 rather than the side of the device 110.

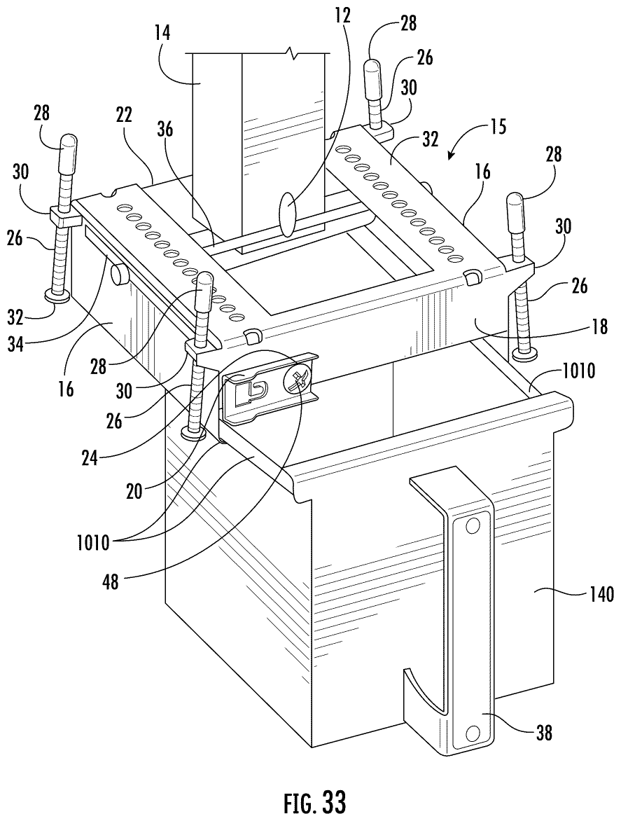

According to another aspect of the presently disclosed invention, the enclosure shown is mounted to the bottom or underneath surface of the cooking enclosure 150. Different manufacturers of outdoor cooking devices 110 have differently configured cooking enclosures 150 and drains 130 and the presently claimed invention is universally adaptable to accommodate these manufacturer differences. For example, some cooking device 110 models have side drains 130 as previously shown and described and some have drains 130 on the bottom or other surface. Downward facing drains such as on the bottom facing surface of the cooking device 150, hereinafter referred to generally as 10, have various configurations such as, but not limited to, a drain opening (such as, e.g., a mere hole) or a downwardly extended bottom spout 14 of any length or configuration (FIG. 33, e.g.). As shown in FIG. 33, cooking device downward spouts 14 often include a pin or clip 12 traditionally used to support a hanging basket as described above. It is advantageous that the grease containment system 100 be universally adaptable to differently configured outdoor cooking devices whether as a side mounted fluid containment device 140 or an undermounted fluid containment device 140.

It is advantageous and novel to provide an upper portion 200 in the form of a universal bracket 15. As used herein the terms “upper portion” and “universal bracket” are used interchangeably inasmuch as the upper portion 200 and the universal bracket 15 both slidably support the lower enclosure 140 whether mounted to the side or bottom of the cooking enclosure 150. Reference will be made to a universal bracket 15 with respect to FIGS. 30 and 32-37 understanding that the term “bracket” is also used to describe an upper portion 200.

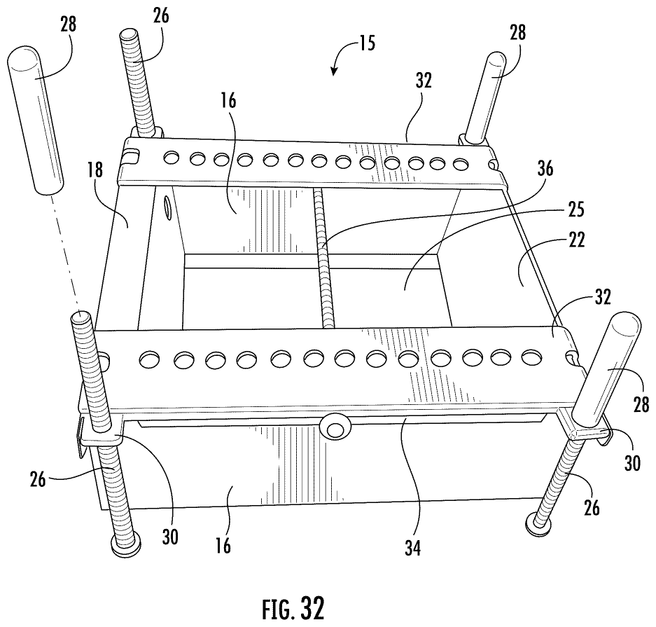

The universal bracket 15 has at least one perimeter wall having first and second sidewall portions across from one another, for example parallel to one another in the example shown, and at least a third portion extending between the first and second sidewall portions. An exemplary configuration is shown including four walls including two rail supporting, parallel walls 16 as the side portions which, as shown in the orientation of FIG. 32, appear as sidewalls, and a fore wall 18 and aft wall 20 (one of which is the third side portion herein), thus forming a rectangle or square. Of course, other configurations are envisioned and within the scope of the present invention and the universal bracket may include less than or more than four walls and even one continuous wall, such as a circle wherein a single sidewall is provided having side, fore, and/or aft portions. The rail supporting walls 16 each have a downwardly extending rail 1010 as best shown in FIG. 33. According to one aspect of the invention, both the fore end of bracket 15 and the aft end of bracket 15 having downwardly extending rails 1010. This configuration provides an entry point for the enclosure 140 from either end of the bracket 15 as described herein, adding to its universal fit to various cooking devices 110. It is also within the scope of the invention that only one end, fore or aft, provide an entry location for the enclosure 140. As shown, the rails 1010 extend along the length of the bracket 15. However, the rail 1010 may extend only along a portion of the enclosure 140 length, even to define one or more tabs or flanges. As used herein, a “rail” may be of any length along the enclosure 140.

At least one or both the fore 18 and aft 22 walls include an aperture 24 for receipt of a lock 20 described herein. At least one, or as shown a pair of horizontal band(s) extend across the universal bracket 15 upper surface to cooperate with a bracket accessory as explained below. Opposing walls, such as sidewalls 16, define a crossbar receiving aperture 34. A crossbar 36 extends through apertures 34 and across the universal bracket 15. As shown, the fore wall 18 is thicker than the aft wall 22. This is exemplary, and the wall thicknesses may be reversed or both the fore 18 and aft 22 walls may have the same thickness. Certain cooking devices may have dimensions requiring a thicker aft wall 22, for example, to receive and/or cooperate with the universal bracket 15.

At least one, or four as shown, leveling members 26 are supported on the universal bracket 15. As shown in FIGS. 32 and 33, four leveling members 26 are provided. The universal bracket 15 includes outwardly extending supports 30 which define an aperture configured for receipt of a respective leveling member 26. A cover 28 is provided for each leveling member 26 according to one aspect of the present invention. The cover, if provided, is formed of a material, such as an extruded polyurethane or plastic, which facilitates cooperation with the cooking device 100.

The universal bracket 15 is thus configured for use on a variety of cooking devices 110 due, in part, to its novel configuration and adaptability to different cooking device 110 configurations and designs. In operation, the crossbar 36 is positioned within the cross bar apertures 34 of the bracket 15. The cross bar 36 is moveable along the length of the crossbar apertures 34. Its location along the apertures 34 is determined by the configuration of the cooking device 110. When the preferred location is located, the crossbar 36 may be secured in its location utilizing the screw on one end and a washer on the opposing end of the crossbar 34 as shown in the various figures. The universal bracket 15 is then positioned on the downward extending spout 14 so that the crossbar 36 engages the clip 12 on the downward spout 14 as shown best in FIG. 33. If necessary, the crossbar 36 position may be adjusted and resecured. The universal bracket 15 is the supported by the downwards spout 14. The universal bracket is secured against the cooking device 110 and leveled relative to the cooking device 110 utilizing the leveling members 26. As shown in FIGS. 32 and 33, the leveling members 36 have a threaded outer surface which engage the aperture is 24 on the supports 30 wherein in the length of the leveling member 36 is adjustable so that its upper end engages the cooking device 110. When the covers 28 are utilized, they may be applied at any stage of this process. The leveling number is 28 are then screwed upward, such as by rotation, and the covers 28 provide cushioning and frictional support to cooperate with the bottom of the cooking enclosure 150. The universal bracket 15 beneficially can be used with a variety of cooking devices 110 due to its adaptability including its ability to be leveled for variously configured cooking devices 110. This is facilitated by having four leveling members 26 which are individually adjusted to accommodate variously configured cooking devices 110. Of course, one or more leveling members may be fixed and wherein only one or more are adjustable. When the leveling member is 26 are securely urged against the bottom of the outdoor cooking enclosure 150, the universal bracket 15 is securely affixed to the bottom of the cooking device 110.

As best shown in FIG. 33, the fluid containment system 100 also includes an enclosure 140 which cooperates with the universal bracket 15 to receive the fluid exiting from the outdoor cooking device 110. The enclosure 140 has at least one perimeter wall having first and second sidewall portions across from one another, for example parallel to one another in the example shown, and a fore and aft portion each extending between the first and second sidewall portions. The enclosure 140 also includes a bottom surface which, together with the sidewalls, fore wall and aft wall, form a fluid receiving cavity for collecting the cooking fluid from the cooking device 110.

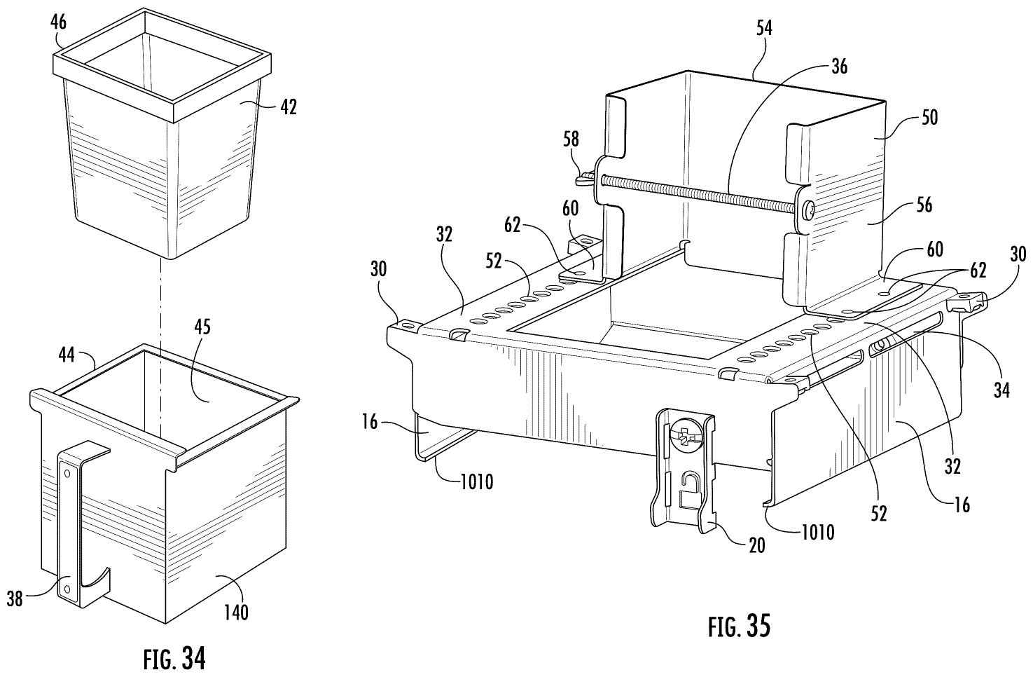

As shown, the enclosure 140 has a square configuration consistent with the configuration of the universal bracket 15 shown in FIGS. 33 and 34. It is within the scope of the present invention however for other configurations to be employed. The configuration shown including four walls is provided for discussion and is exemplary in nature. The enclosure 140 configuration shows is generally consistent with the bracket 15 configuration, but it is within the scope of the present invention that these configurations are different from the other. The enclosure 140 includes a handle to facilitate its manipulation. Opposing sidewalls of the enclosure 140 include mating members, for example ash shown rails 1010, extending along the upper edges thereof. The mating member of the enclosure 140 cooperate with the rails 1010 of the universal bracket 15 as best shown in FIG. 33 and as described herein with respect to other aspects the present invention. As shown, the mating member is a rail 1010 which extends along the length of the enclosure sidewall. Other mating member configurations are envisioned to cooperate with the rail 1010 or differently configured mating member of the bracket 15. However, the rail 1010 may extend only along a portion of the bracket 15 length, even to define one or more tabs or flanges. As used herein, a “rail” may be of any length along the bracket 15.

FIG. 30 illustrates the enclosure 140 in a first position wherein the enclosure 140 is generally fully inserted onto the rails 1010 of the bracket 15 and the upper open end of the enclosure 140 is positioned below the open bracket 15 defined within the sidewalls 16, fore wall 18 and aft wall 20. Cooking fluid exiting the cooking device, thus, is expelled from the cooking device 110, through the opening 25 of the bracket 15, and into the open upper end 45 of the enclosure 140 which are in fluid communication. FIG. 33 illustrates the enclosure 140 being removed from the bracket rails 1010 and, ultimately, the enclosure 140 is pulled out to a second position, such as for emptying or cleaning, wherein the enclosure upper end is not directly aligned with the bracket 15 opened middle portion defined between the bracket sidewall.

As shown in FIG. 34, an insert 42 is provided to line the interior surface of the enclosure 140. It is within the scope of the present invention, however, that the insert 42 is not provided and that the enclosure 140 directly receive cooking fluids and is simply cleaned after use. According to an exemplary aspect, the insert 42 is formed of a thermoplastic such as silicone or the like. The insert 42 may be formed of a material which may be reused, such as a plastic or a formed metal, or it may be formed of a disposable material, such as foil. A liner support 44 may be provided along the upper edges of the side walls forming the enclosure 140 as shown in FIG. 33. The liner 42 shown also includes an upper edge 46 configure to cooperate with the liner support 44 of the enclosure 140.

Accordingly, when the universal bracket 15 is secured to the outdoor cooking device 110 as previously discussed, the user may grip the handle 38 of the enclosure 140 to position the enclosure rails 1010 to mate and cooperate with the rails 1010 of the universal bracket 15 as shown best in FIG. 33. As set forth above, universal bracket 15 has at least one side within which the enclosure 140 may be inserted or more than one side, such as the fore and aft sides. A lock 20 is provided on the fore and aft sides of the universal bracket 15. A screw 48 secures the lock 20 through the aperture 24. According to one aspect of their present invention, the lock pivots about the screw 48 permitting rotation so as not to interfere with insertion of the enclosure 140. When the enclosure 140 is positioned within the universal bracket 15, the lock 20 is rotated in a downward position to secure the enclosure 140 within the universal bracket 15. The lock 20 on the side of the universal bracket 15 opposite the side within which the enclosure 140 is inserted, may also have a lock 20. If provided, the opposing lock 20 is in the locked position to prevent the enclosure 140 from being pushed beyond the opposite end of the universal bracket 15.

The description above regarding FIGS. 32 and 33 pertain to an outdoor cooking device having a downwardly extending drain 10 upon which the universal bracket 15 is supported. Not all cooking devices 110 include a drain 10, in the configuration of a spout as shown in FIG. 33. And other cooking devices may have a downward extending drain 10 but which is of a length requiring application of the universal bracket 15 by alternative methods. Aspects of the present invention which facilitate these cooking devices 110 are shown in FIGS. 35-37.

FIG. 35 illustrates an adapter 50 mounted on the bands 32 of the universal bracket 15. The bands 32 include at least one, or as shown, a plurality of coupling members, shown by way of example in the form of apertures 52. Other coupling members are also envisioned as is known in the art. The adapter 50 includes aft wall 54 and two side walls 56. The side walls 56 each include an aperture for receipt of a crossbar 36 having a wing nut 58 on one end and a screw head on the other end. When inserted across the side walls 56 of the adapter 50, the crossbar 36 may be tightened utilizing the wing nut 58 or other fastening means as shown in FIG. 35. The crossbar 36, thus, cooperates with the clip 12 and underneath drain 10 or downward spout 14. As provided on the outdoor cooking device 110. The adapter 50 includes outwardly extending flanges 60 having apertures 62 corresponding to respective apertures 52 of the bands 32 on the universal bracket 15. Fastening members are then inserted into the apertures of the flanges 60 and bands 32 to secure the adapter 50 to the universal mounting bracket 15. According to the aspect shown in FIG. 35, the universal bracket 15 is supported by the adapter 50 on the downward spout 14 or other drain 10 of the outdoor cooking device 110. As described above, the enclosure 140 may then be applied to the universal bracket 15 utilizing the rails 1010 of the universal bracket 15.

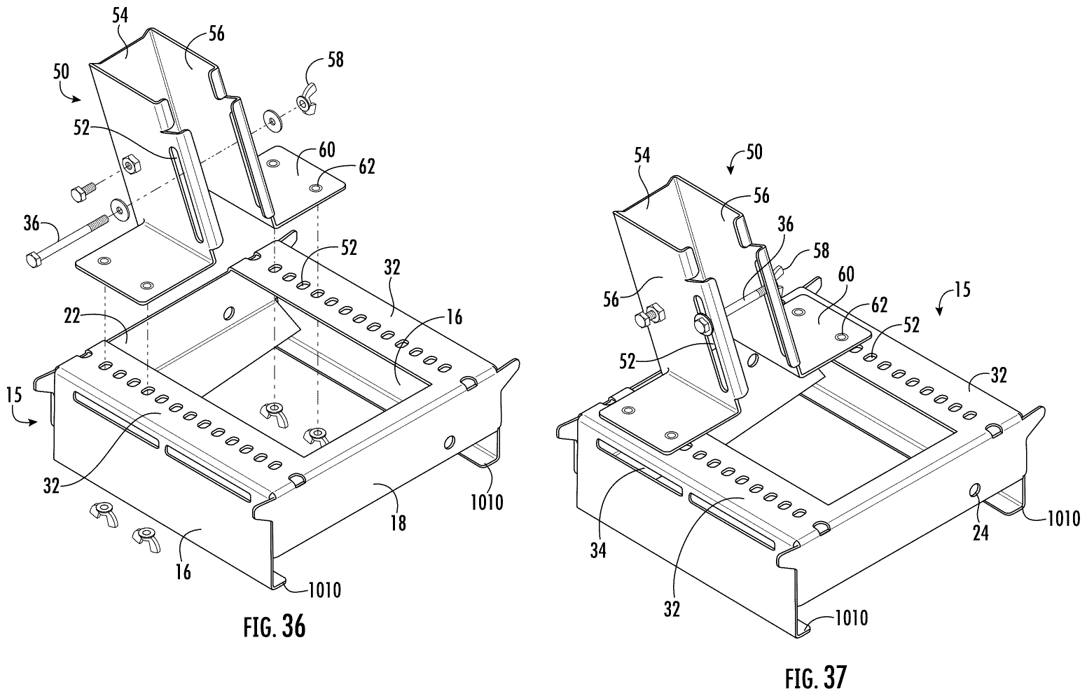

FIGS. 36 and 37 further illustrate the adaptability of the universal bracket 15 according to the presently disclosed invention. FIGS. 36 and 37 illustrate a differently configured adapter 50 to facilitate a differently configured outdoor cooking device 110. In the aspect shown in FIGS. 36 and 37, the vertical height of the crossbar 36 is adjustable whereby the aperture 52 extends longitudinally a predetermined distance along the height of the adapter 50 to provide further adjustability of the universal bracket 15.

As shown in the various Figures, the universal bracket 15 is provided as an accessory to the cooking device. It is within the scope of the present invention, however, that the universal bracket 15 described herein may be permanently mounted to or within a cooking device without departing from the spirit and scope of the claimed invention. This applies to all mounting mechanisms disclosed throughout this disclosure.

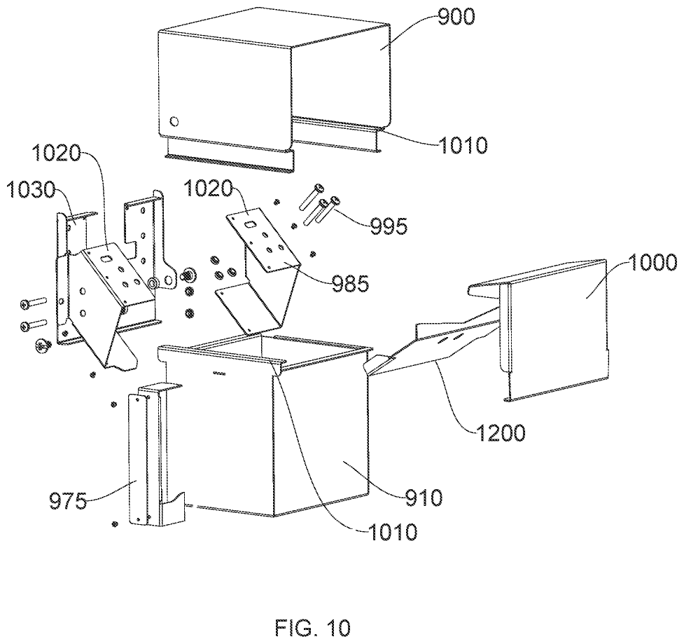

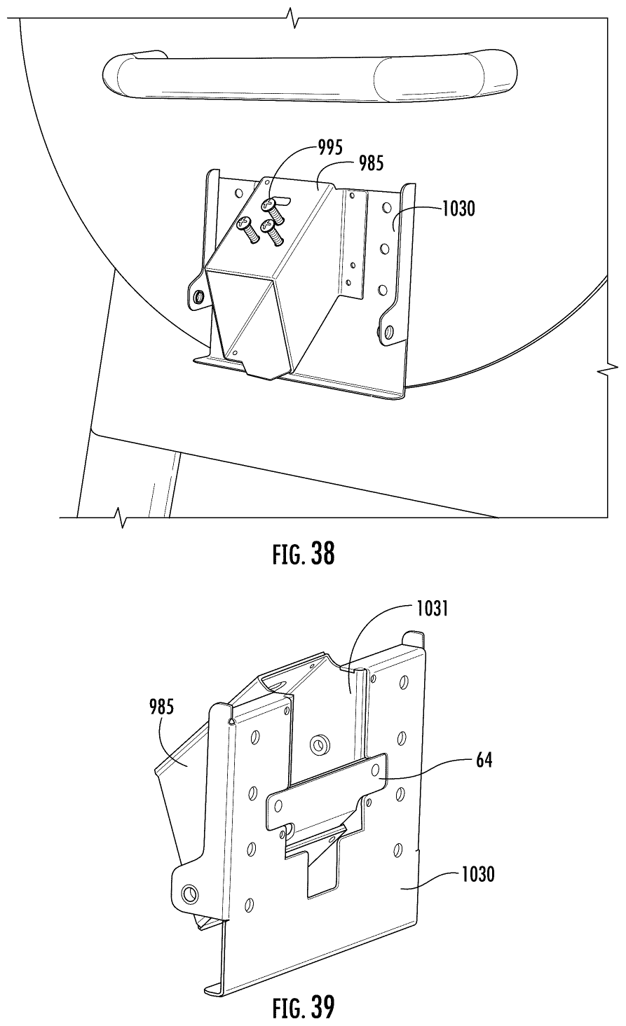

FIGS. 38 and 39 illustrate an internal amount 985 for use with a cooking device 110 that requires a side mount fluid containment system 100 such as that shown and described with regards to FIG. 10 above. As shown in FIG. 38, the internal amount 985 is connected to a mounting base plate 1030 that is secured to the side of the cooking device 110. Fasteners 995 are provided to secure the internal amount 985. As described above, an upper portion 200 is then positioned on the internal mount 985. FIG. 39 shows the rear side of the internal mount 985 and, more specifically, the rear side of the mounting base plate 1030. For certain models of outdoor cooking devices 110 having unique specifications, a deflector 64 is utilized. As shown in FIG. 39, the deflector 64 cooperates with the rear side of the mounting base plate 1030 and opening 1031 thereon, through which fluid may be properly directed through the internal mount 985. The ability of the fluid containment system 100 according to the presently disclosed invention further is universally adaptable to various cooking devices-including with the ability to use a deflector such as deflector 64.

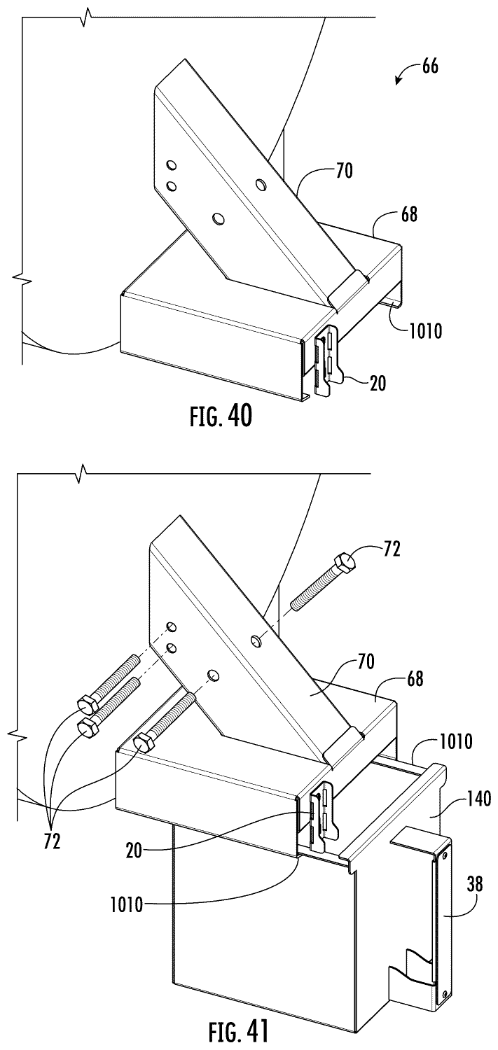

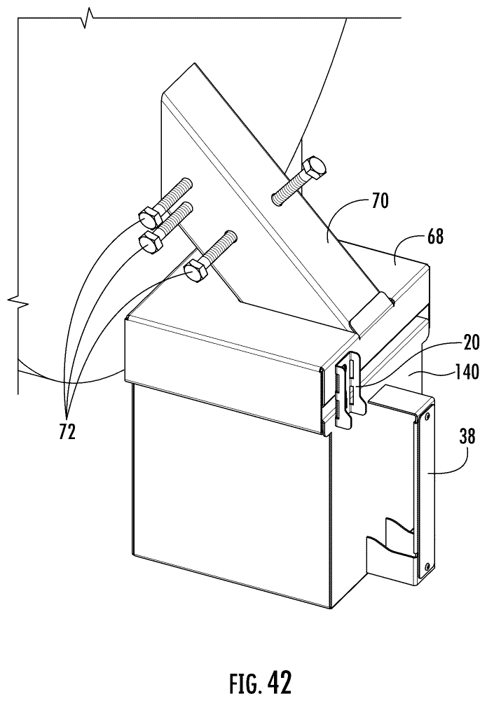

The aspect of the present invention shown in FIGS. 8-13B and 38 provides for an upper portion 900 which mates with the internal mount 985 to enclose the mount. FIGS. 40-42 illustrate a fluid containment system 100 having a cooking enclosure 66 having an upper portion 68 which does not fully enclosure the mount 70. The mount 70 extends external to the upper portion 68 which is beneficial for particular cooking devices 110 which have, for example, a shelf, ash cleanout or other structure necessitating a differently configured upper portion 68. Other configurations are also envisioned and within the scope of the present invention. The mount 70 is configured to receive a spout extending from the cooking device 110, such as on the side of the cooking enclosure 150. Screws 72 are provided and extend through apertures along the mount 70 to secure to the cooking device to the drain 130. The mount 70 and upper portion 68 may separate structures or securely affixed, such as by welded, to provide a unitary structure.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

1. A fluid containment enclosure for collecting fluids from an outdoor cooking device comprising:
a bracket comprising a perimeter wall having opposing first and second side portions and at least one third wall portion extending between said first and second side portions, said bracket further comprising a bracket opening between said first and second side portions, said bracket further comprising a crossbar extending across said first and second side portions wherein said crossbar is configured to cooperate with the outdoor cooking device to support said bracket on the outdoor cooking device, said bracket further comprising a bracket rail on at least one of said first and second side portions; and
an enclosure comprising a sidewall having opposing first and second side portions, a fore portion, and an aft portion, said fore portion and said aft portion each extending generally between said first and second side portions wherein at least one of said first and second side portions includes a mating member to cooperate with said bracket rail and wherein said enclosure includes an opening on an upper surface thereof, and wherein said enclosure is moveable from a first position below said bracket wherein said bracket opening is in fluid communication with said enclosure opening to a second position wherein said enclosure is withdrawn from said bracket.

2. The fluid containment enclosure according to claim 1 wherein said rail extends generally along the length of at least one of said first and second side portions.

3. The fluid containment enclosure according to claim 2 wherein said rail extends adjacent a bottom edge of said at least one of said first and second side portions.

4. The fluid containment enclosure according to claim 1 wherein said first and said second side portions each include said rail.

5. The fluid containment enclosure according to claim 4 wherein said enclosure mating member is configured to be inserted into said rails adjacent a fore end of said bracket for insertion of said enclosure into said bracket.

6. The fluid containment enclosure according to claim 1 wherein said crossbar is moveable along said first and second side portions.

7. The fluid containment enclosure according to claim 6 wherein said first and second side portions each define an aperture configured for receipt of said crossbar and said aperture has a predetermined length permitting said crossbar to move along said predetermined length within said aperture.

8. The fluid containment enclosure according to claim 1 wherein said crossbar has a securing member on one end to secure the position of said crossbar on said bracket.

9. The fluid containment enclosure according to claim 1 further comprising at least one leveling member configured to cooperate with the outdoor cooking device to secure said bracket against said outdoor cooking device.

10. The fluid containment enclosure according to claim 9 wherein said leveling member extends generally perpendicular to said bracket and is moveable from a first position to a second position wherein said second position is extended upward relative to said first position in relation to said bracket so as to urge against the outdoor cooking device.

11. The fluid containment enclosure according to claim 10 further comprising at least two leveling members positioned on opposing portions of said bracket perimeter wall.

12. The fluid containment enclosure according to claim 1 further comprising a lock moveable between a locked and unlocked position for locking said enclosure in said first position.

13. The fluid containment enclosure according to claim 12 wherein said lock is mounted to said bracket and rotates between said locked and unlocked positions.

14. The fluid containment enclosure according to claim 1 wherein said bracket further comprises at least one coupling member adjacent an upper surface thereof.

15. The fluid containment enclosure according to claim 13 wherein said bracket further includes at least one band extending a predetermined distance adjacent at least one of said first and second side portions of said bracket and said bands includes said coupling member.

16. The fluid containment enclosure according to claim 15 wherein said bracket includes two of said bands which extend parallel to and adjacent a respective one of said first and second side portions.

17. The fluid containment enclosure according to claim 14 further comprising an adapter selectively extending generally perpendicularly upward from said bracket and having adapter first and second sides wherein said crossbar extends between said adapter first and second sides.

18. The fluid containment enclosure according to claim 17 wherein said adapter includes at least one flange for coupling with said bracket coupling member.

19. The fluid containment enclosure according to claim 1 further comprising a liner configured for receipt within said enclosure.

20. The fluid containment enclosure according to claim 1 wherein said perimeter wall further comprises a fourth wall portion wherein said first and second sidewalls and said third and fourth wall portions define a four-sided configuration having four corners.

21. The fluid containment enclosure according to claim 19 wherein said bracket comprises two of said locks on said perimeter wall to cooperate with said third and fourth wall portions.

22. The fluid containment enclosure according to claim 20 further comprising at least four leveling members each positioned adjacent one of said four corners.

23. The fluid containment enclosure according to claim 20 further comprising at least one leveling member configured to cooperate with the outdoor cooking device to secure said bracket against said outdoor cooking device, wherein said leveling member extends generally perpendicular to said bracket and is moveable from a first position to a second position wherein said second position is extended upward relative to said first position in relation to said bracket so as to urge against the said outdoor cooking device.

24. A fluid containment enclosure for collecting fluids from an outdoor cooking device having a drain, said fluid containment enclosure comprising:
an upper portion comprising a perimeter wall having opposing first and second side portions and at least one third wall portion extending between said first and second side portions, said upper portion further comprising a rail on at least one of said first and second side portions and a top surface extending substantially between said first and second side portions;
an enclosure comprising a sidewall having opposing first and second side portions, a fore portion, and an aft portion, said fore portion and said aft portion each extending generally between said first and second side portions wherein at least one of said first and second side portions includes a mating member to cooperate with said upper portion rail and wherein said enclosure includes an opening on an upper end thereof, and wherein said enclosure is moveable from a first position below said upper enclosure wherein an upper enclosure opening is in fluid communication with said enclosure opening to a second position wherein said enclosure is withdrawn from said bracket; and
a mount configured for receipt of the outdoor cooking device drain wherein said mount extends upwardly from said upper portion top surface wherein said mount extends from said upper portion top surface to said outdoor cooking device drain to receive the drain and secure the fluid containment enclosure thereto.
